(19) United States
(12) Patent Application Publication
(10) Pub. No.: US 2016/0335681 A1
(43) Pub. Date: Nov. 17, 2016

(54) Selectively Shared and Custom-Branded/Re-branded Online Subscription Merchandising

(71) Applicant: David Benjamin Swanson, Sarasota, FL (US)

(72) Inventor: David Benjamin Swanson, Sarasota, FL (US)

(21) Appl. No.: 14/705,483

(22) Filed: May 6, 2015

Related U.S. Application Data
(60) Provisional application No. 61/992,840, filed on May 13, 2014.

(51) Int. Cl. G06Q 30/02; G06F 17/30

(52) U.S. Cl. CPC G06Q 30/0277; G06F 17/30867; G06Q 50/16

(57) ABSTRACT

Present invention concerns software-driven subscription services providing custom-branded all-inclusive Member Websites and custom branded Marketing Materials including, among others, online Virtual Tours and Stand-alone Videos. Present invention further and uniquely provides means whereby such Branded Merchandise and related Marketing Materials originating with one Member Subscriber can be selectively shared with other Member Subscribers and Custom Re-branded for dissemination across all platforms and media concurrently, independent of browsers and viewers and mitigating meta data without loss of control of merchandise or merchandise listing by Originating Member Subscriber or loss of sales credit to shared Member Subscriber upon successful sale of offered merchandise.

### FIELD OF THE INVENTION

The present invention relates generally to online merchandising. In particular, the present invention relates to methods and means for merchandising real estate and other types of merchandise or services where the listing or items offered may be selectively provided in branded form by one Member Subscriber (real estate agent) and shared with other Member Subscribers (real estate agents) where the offered items are uniquely branded to each Member Subscriber (agent) marketing the shared item or listing.

### BACKGROUND OF THE INVENTION

Depending on local regulations, in any number of transaction types—but in real estate in particular, Owner's Agents are not allowed to represent both the Owner and a Prospective Buyer in a sales, lease, or rental transaction without full—and often complicated and confusing—disclosures to all parties.

Since the Seller wants the highest price, and the Buyer wants the lowest price, the assumption under law and custom is that a single agent for both parties will have a difficult time maintaining neutrality, though provisions under local governing laws may allow such transactions to take place with full disclosure. However, even with such full disclosure, where there is a single Agent representing or overseeing the transaction for both parties, there is often misunderstanding and negative litigation that can follow if either the Owner or the Buyer feels slighted in either the negotiations or the final transaction.

To avoid this apparent conflict of interest, Agents with a Property to market (“Listing Agent” or “Owner's Agent”) typically expend the majority of their efforts marketing the property to other Agents, depending upon such other Agents to find and represent Prospective Buyers to complete a transfer of rights. Further, not all Agents are as adept at finding and listing Properties as they are at finding and shepherding Prospects. And Agents with a good rapport with and lead bank full of Prospects may not be as practiced at securing contracts for Properties for Listings. Hence, there often exists the necessity for the mutual dependency of one type of Agent on the other.

By default, among other tools, Listing Agents subscribe to and use a local compendium of Listings such as the local Multiple Listing Service (“MLS”)—a kind of catalogue of available properties—to post information about the particular Listings they represent.

Buyers' Agents, also by default, primarily refer to the MLS catalogue—discretely available online to the buying public by Agent referral—when trying to appeal to the buying interests of their contracted or prospective clientele in searching for available properties for consumption.

Further, it is estimated that upwards of eighty to ninety percent of all completed real estate (and other types of hard goods and services) transactions are increasingly related to online searches if not also consummated online. Mobile devices—such as smart phones and tablets—are accounting for the vast majority of such searches and sales, and the trend is only expected to increase.

To capitalize on this demand, successfully aggressive Listing Agents (as well as their Buyers' Agents counterparts) spend substantial amounts of time and money to create uniquely branded websites and other forms of web-based advertising in order to keep the commercial identification of the Agency and themselves as Agents in full view for all to see. Unfortunately, the industry has been slow in keeping pace with the shift in online viewing habits away from fixed computers to smaller, more mobile devices and the limited viewing challenges presented by the newer media technology.

For both Owners' and Buyers' Agents, among the most effective contemporary tools for the internet are “Virtual Tours”, typically comprised of (1) a series of still photographs (“slide presentations”) that morph together to give the appearance of a “video tour” of the property, (2) panoramic images that offer a broader viewing perspective, (3) an actual motion video of the property, or (3) a combination of two or more of the first three options. Properly crafted and presented Virtual Tours provide a way for Prospective Buyers to become interested enough to want to visit a property in person without expending the time and expense of an actual visit if one is not warranted.

Currently, and for the far foreseeable future—for both legal and practical reasons, in certain jurisdictions only Listing Agents are able to directly or indirectly lawfully create and publish virtual tours or most other forms of advertising and marketing materials for the properties they are under contract to list.

While necessary in order to compete, effective virtual tours are not cheap or easy to produce and may often require the services of professional photographers and other technical trades in the process.

The better and more commercially effective virtual tours include a substantial amount of “branding” in their presentation, tying the Listing Agent to the offered property.

Then, to get any kind of return on their virtual tour investment, Listing Agents must spend additional time and money to drive traffic to their websites in order for the tours to be viewed.

Should a Listing Agent's submission of data to their relevant Multiple Listing Service (“MLS”) include such necessary but costly Virtual Tours, local rules require that such tours must be submitted for MLS access by other Agents without any “branding”—no visual or other reference to the Listing Agent as the Listing Agent of record as part of such a “tour”. This is so as to not appear to give an unfair advantage to the Listing Agent if a Buyer's Agent is using the MLS to promote a property to a Prospect. (Some Buyer's mistakenly believe that by dumping their Buyer's Agent and going directly to the Listing Agent that they will “cut out the Middleman” and save sales commissions. Brandless “Vanilla Tours” are an attempt to avoid such a circumstance.)

Oftentimes, unfortunately, providing a brand neutral or “Vanilla Tour” either requires the expense of the creation of a separate Virtual Tour in addition to the branded version, or some Agents create only the brandless version and lose out on the advantage of a quality branded tour on their own websites.

The present invention uses unique multi-platform technology to greatly enhance both the creation and viewing experiences of Virtual Tours and Videos and other related Marketing Materials—regardless of viewing size or media—while positively changing the disadvantages of the existing system and providing desirable options never before available to the industry.

### SUMMARY OF THE INVENTION

The present invention concerns proprietary software-driven subscription services and products of same—in the form of Marketing Materials—which provide individually and uniquely branded all-inclusive Websites to qualified Member Subscribers (real estate agents, among others), and means and materials for the marketing of the listed merchandise by such Member Subscribers to potential consumers.

Merchandise contemplated for promotion by the present invention includes, without limitation, real estate, hard and soft goods, and any other lawfully offered items or services for sale, lease, rent, or hire.

The present invention concerns the marketing/promotion of actual Merchandise itself—or at least contractually secured listings representing same, together with all related Marketing Materials—whether available via online viewing, downloading, and/or disseminated or communicated by any other publication means or media.

Such Merchandise or Listings of same are designed to be offered under and embedded with the individual and unique Custom Brands/Re-brands of the Member Subscribers offering and marketing such Merchandise and/or Listings.

Marketing Tools and Materials utilized or provided by means of the present invention include, but are not necessarily limited to, such items as the Website itself; Social Networking Building and Tracking; Virtual Tours; Landing Pages; Capture Pages; custom-generated Emails; Text Messages and Messaging; downloadable, printable, and printed Flyers, Brochures, Pamphlets, Leaflets, Post Cards, Documentation, Manuals, Posters, and such like; Blogs and Blog Articles; Audio enhancements and/or Presentations; Stand-alone Videos; and Translation Services regarding any of the above.

The present invention provides the means whereby Merchandise and related Marketing Materials and means offered and provided by at least one Originating Member Subscriber under said Originating Member Subscriber's unique and individual Brand and Branded Website can, by Permission selectively granted by said Originating Subscriber and received by at least one consenting receiving Member Subscriber, be wholly or in part shared with such receiving and consenting Member Subscriber and, upon reception, be Re-branded and offered to consumers as though originating with the Re-branding Agent.

The present invention replicates data and Marketing Materials in such a way as to not get content flagged as duplicate by current search engine algorithms.

The present invention at all times leaves the Originating Subscriber in control of the Merchandise and/or Listing of same and allows for real time analytical analysis and monitoring of any and all internet-related marketing efforts put forth by a receiving Member Subscriber.

The present invention is specifically designed to allow such Merchandise and/or Listing of same so selectively shared and received to be offered to the public concurrently by both the Originating Member Subscriber and any and all Receiving Member Subscribers without loss of control of the merchandise or merchandise listing by the Originating Member Subscriber.

The present invention is specifically designed to allow Member Subscribers who originate and share system-resident Listings to retain control and integrity of the Content of any and all Marketing Materials they create for those Listings by and through the System other than for the Custom Re-branding the system facilitates on behalf of Receiving Member Subscribers—without the loss of sales credit to either the Originating or a Receiving Member Subscriber upon completion of a successful sales transaction involving both such Member Subscribers.

### BRIEF DESCRIPTION OF THE INVENTION DRAWINGS

The present invention will be described by examples that in no way limit the functionality being illustrated to the specific examples given, while similar references within the illustrations denote similar elements and in which:

FIG. 1 (elements 100-278) is an overview flowchart representing the flow of user experience and information through seventeen (17) primary steps for five (5) (hypothetical) Member Subscribers depicted as Agents “A-E”.

FIG. 2 illustrates the sign up or sign in procedure whereby Members can begin to access the unique features of the present invention for the marketing of merchandise—a/k/a “Properties”—to the public.

FIG. 3 illustrates the initial online BackOffice where a Member Subscriber begins to develop an online marketing profile for presentation to the public for the purpose of reaching and engaging Prospects and Customers.

FIG. 4 illustrates the steps whereby a Member Subscriber begins to establish online friendship or networking connections with other Member Subscribers in order to involve other Member Subscribers in the joint marketing efforts of goods and services—a/k/a “Property Listings”—they may mutually offer to their own unique Prospects and Customers.

FIG. 5 illustrates the first steps in establishing and maintaining an inventory of Property Listings that can be selectively shared with and re-branded by other Member Subscribers for offering to their respective Prospects and Customers.

FIG. 6 illustrates the process of building an online Virtual Tour of a Property Listing which can be shared with and re-branded by other Member Subscribers for marketing to their respective Prospects and Customers.

FIG. 6a illustrates the process of building an online Landing Page—a/k/a “Capture Page”—for a Property Listing which can be shared with and re-branded by other Member Subscribers for marketing to their respective Prospects and Customers.

FIG. 6b illustrates the process of building an online Printable .pdf Flyer page representing a Property Listing where such Flyer can be shared with and re-branded by other Member Subscribers for marketing to their respective Prospects and Customers.

FIG. 6c illustrates the process of building an online Printable .pdf Post Card of a Property Listing where such Post Card can be shared with and re-branded by other Member Subscribers for marketing to their respective Prospects and Customers.

FIG. 6d illustrates the process of building a Stand-alone Video Tour that can be shared with and re-branded by other Member Subscribers for downloading or viewing online for marketing to their respective Prospects and Customers.

FIG. 7 illustrates a select package of Branded Marketing Materials that can be built online for marketing Property Listings directly to the public whether or not such Property Listings and their Marketing Materials are selectively shared with and re-branded by other Member Subscribers for marketing to their respective Prospects and Customers.

FIG. 7a illustrates the baseline and distinctively branded elements of a branded/rebranded Virtual Tour of a Property Listing as it might appear for marketing to a Member Subscriber's Prospects and Customers.

FIG. 7b illustrates the baseline and distinctively branded elements of a branded/rebranded Landing Page of a Property Listing as it might appear for marketing to a Member Subscriber's Prospects and Customers.

FIG. 7c illustrates the baseline and distinctively branded elements of a branded/rebranded online Printable. pdf Flyer of a Property Listing as it might appear for marketing to a Member Subscriber's Prospects and Customers.

FIG. 7d illustrates the baseline and distinctively branded elements of a branded/rebranded online Printable .pdf Post Card of a Property Listing as it might appear for marketing to a Member Subscriber's Prospects and Customers.

FIG. 7e illustrates the baseline and distinctively branded elements of a branded/rebranded online Stand-alone Video Tour of a Property Listing as it might appear for marketing to a Member Subscriber's Prospects and Customers.

FIG. 8 illustrates the selective sharing preferences that Member Subscribers may choose for the visibility of their Property Listings to Prospects and Customers and for sharing with other Member Subscribers for re-branding and marketing of those Property Listings.

FIG. 9 illustrates what an invitation to share and re-brand a Property Listing might look like whether the Initiating/Originating Member Subscriber chooses to handle the process manually or automatically within the system's Friends Network.

FIG. 10 illustrates what a Re-brand Acceptance and Re-brand Authorization for a Property Listing might look like whether the Initiating/Originating Member Subscriber chooses to handle the process manually or automatically within the system's Friends Network.

FIG. 11 illustrates the steps that can be taken by a Member Subscriber to secure authorization from an Initiating/Originating Member Subscriber for sharing a Re-branded Property Listing where there has not been a specific or blanket invitation to do so from the Listing's Initiating/Originating Member Subscriber.

FIG. 12 illustrates a sample package of branded marketing materials built in and through the System by an Initiating/Originating Member Subscriber where the branding has been stripped from the marketing materials in the process of selectively sharing those materials with other Member Subscribers for purposes of their re-branding them for marketing to their own Prospects and Customers.

FIG. 13 illustrates the System's treatment of originally branded Virtual Tours where the Initiating/Originating Member Subscriber's branding is stripped away in the process of selectively sharing the Property Listings with other Member Subscribers, and the unique branding of the Receiving Member Subscribers is electronically substituted, and/or merged, and/or overlaid by the System and made part of the shared Virtual Tour for the purpose of promoting the shared Virtual Tour with the Prospects and Customers of the Receiving Member Subscribers.

FIG. 13a illustrates a Virtual Tour related to a Property Listing initiated/originated by one Member Subscriber who then selectively shares the Virtual Tour with three other Member Subscribers where the System strips the Tour of its original branding and uniquely re-brands the Tour for the Receiving Member Subscribers.

FIG. 13b illustrates Stand-alone Videos related to Property Listings initiated/originated by two Member Subscribers and selectively shared with each other and re-branded for marketing to their respective Prospects and Customers.

FIG. 14 illustrates an example of net increases in the number of branded/re-branded Property Listings offered by each of five Member Subscribers as a result of selective sharing of Property Listings among them.

FIG. 15 illustrates a portion of the scope and flexibility of the Marketing Materials that can be generated by the System for selective sharing among Member Subscribers.

FIG. 15a illustrates some of the available internal Online Tools for use by Member Subscribers in managing and promoting their original and re-branded Property Listings.

FIG. 15b illustrates some of the online pages visibly accessible by the public in the promotion of a Member Subscriber's Initial/Original and Shared/Re-branded Property Listings.

FIG. 16 illustrates the role the System's Lead Protection System plays in helping Member Subscribers track and hold onto Leads from contacts they have made in promoting Branded/Re-branded Property Listings where the same Prospect has received multiple contacts from multiple Member Subscribers regarding the same Property Listing.

FIG. 16a illustrates the role the System's Lead Protection System plays in helping Member Subscribers track and hold onto Leads from contacts they have made in promoting Branded/Re-branded Property Listings where the same Prospect has received multiple contacts from multiple Member Subscribers regarding multiple similar Property Listings.

FIG. 16b illustrates the role the System's Lead Protection System plays in controlling the visibility and redirection of links to Property Listings where a Prospect may have seen and responded to more than one invite from more than one Member Subscriber where the responses might otherwise conflict with previous contacts with another Member Subscriber over the same Property Listings.

### DETAILED DESCRIPTIONS OF ILLUSTRATIVE EMBODIMENTS

The present invention will be described by examples that in no way limit the functionality being illustrated to the specific examples given. Examples of the present invention denote functionalities while the actual look and feel of the online or other manifest presentation and appearance of the present invention and its functions as seen by the public may from time to time vary or change altogether. Similar references within the illustrations denote similar elements in which:

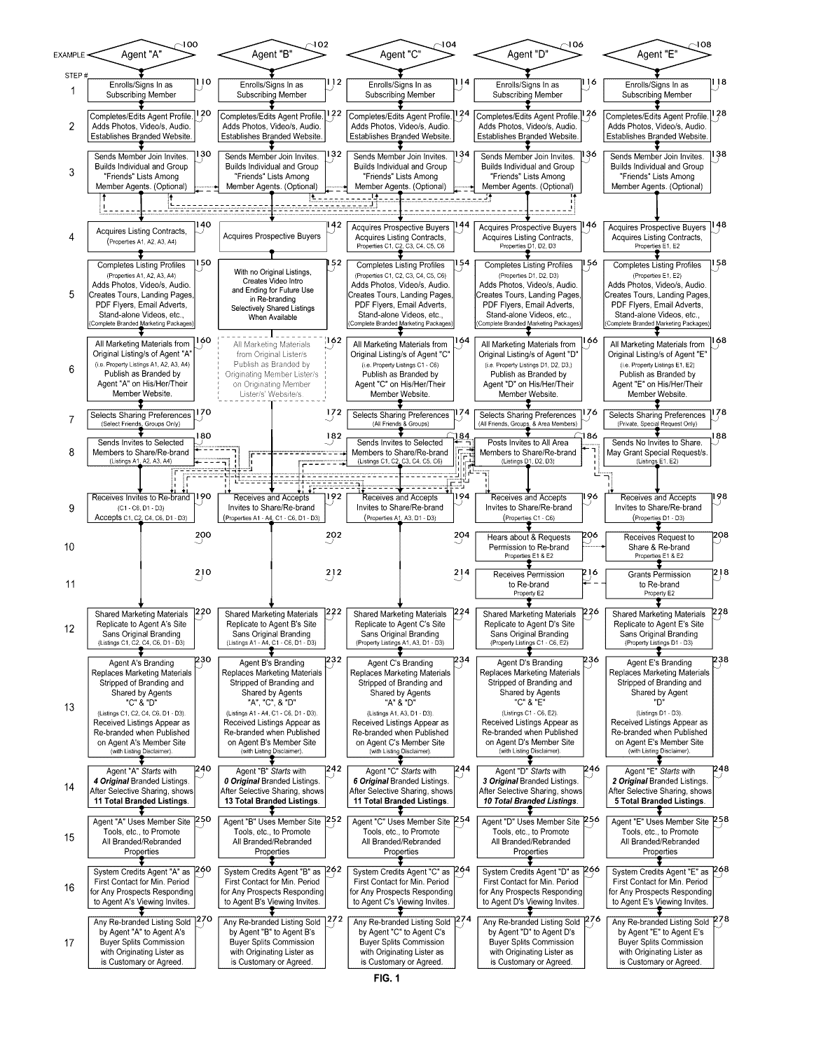

FIG. 1 is a flowchart 100-278 representing the flow of user experience and information through seventeen (17) primary steps for five (5) hypothetical Member Subscribers. “Agent ‘A’” 100 heads and designates the column for hypothetical Agent “A”, and elements thereafter by tens—as in 100, 110, 120, 130, 140, etc., through 270—pertain to Agent “A”. “Agent ‘B’” 102 heads and designates the column for hypothetical Agent “B”, and elements thereafter by tens—as in 102, 112, 122, 132, 142, etc., through 272—pertain to Agent “B”. “Agent ‘C’” 104 heads and designates the column for hypothetical Agent “C”, and elements thereafter by tens—as in 104, 114, 124, 134, 144, etc., through 274—pertain to Agent “C”. “Agent ‘D’” 106 heads and designates the column for hypothetical Agent “D”, and elements thereafter by tens—as in 106, 116, 126, 136, 146, etc., through 276—pertain to Agent “D”. “Agent ‘E’” 106 heads and designates the column for hypothetical Agent “E”, and elements thereafter by tens—as in 106, 116, 126, 136, 146, etc., through 276—pertain to Agent “E”.

The entire process is illustrated by the flowchart of FIG. 1, and the Figures that follow call out and illustrate more fully the individual steps through the seventeen (17) step process. By way of overview, the steps are depicted as follows.

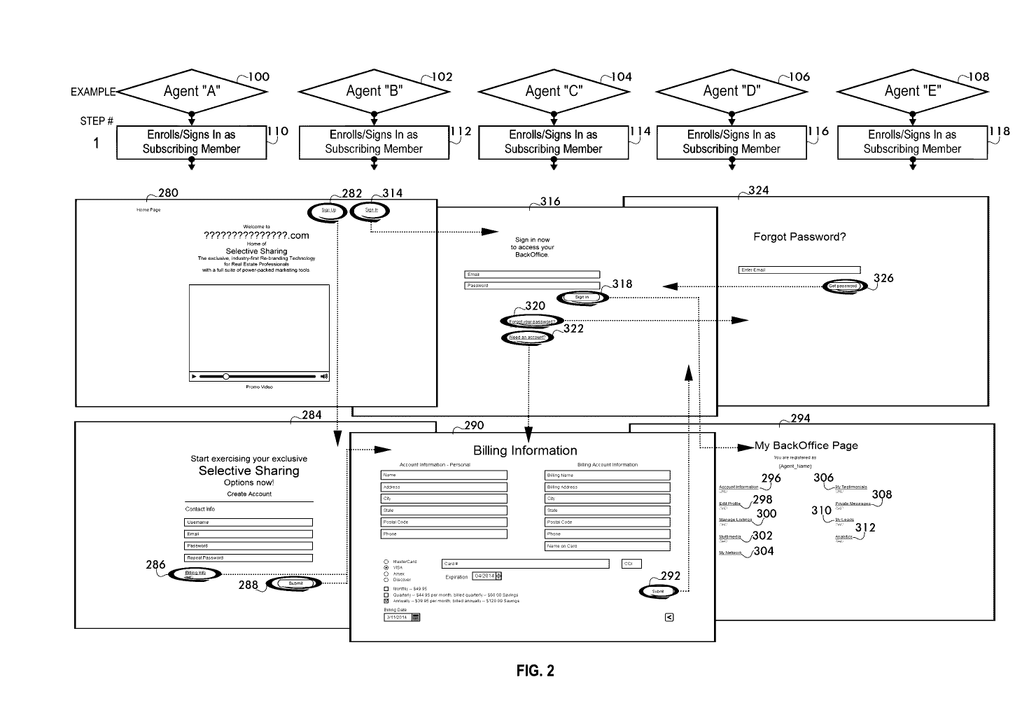

110, 112, 114, 116, 118 indicate Step 1, the “Sign Up” or “Sign In” procedure for Member Subscribers as represented by hypothetical Agents “A”-“E” as illustrated more fully in FIG. 2.

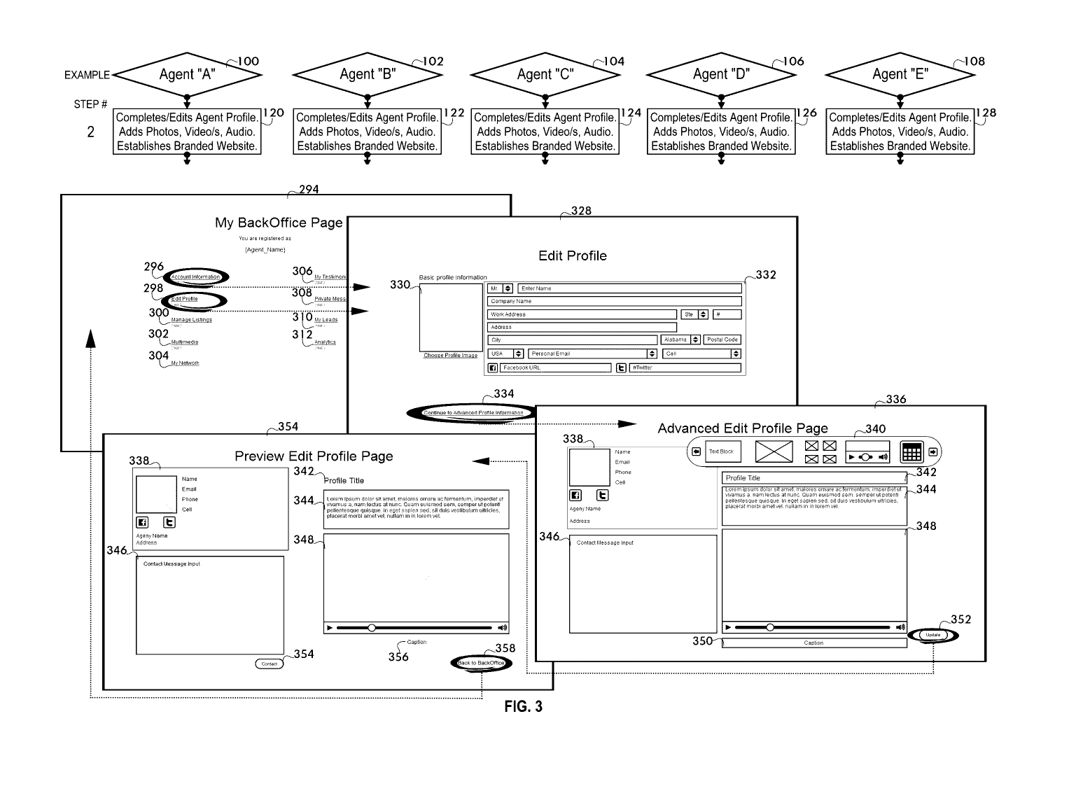

120, 122, 124, 126, 128 indicate Step 2, the process of completing and reviewing the basic and advanced “Agent Profile” procedure for Member Subscribers as represented by hypothetical Agents “A”-“E” as illustrated more fully in FIG. 3.

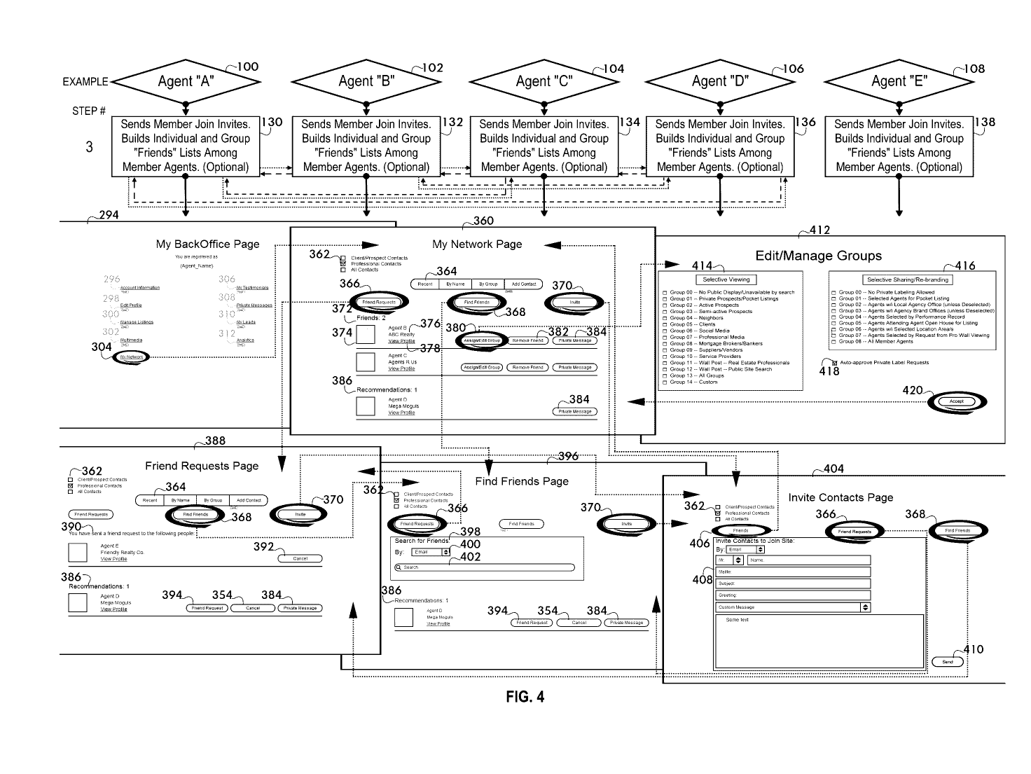

130, 132, 134, 136, 138 indicate Step 3, the process of adding to, maintaining, and managing “Friends” and “Contacts” for selectively sharing and marketing the Property Listings that Member Subscribers have to offer as represented by hypothetical Agents “A”-“E” whereby each sends “Member Join Invites” and builds Individual and Group “Friends” Lists. This activity, though optional, is important to the individual success of Member Subscribers in the utilization of the present invention. This step is more fully illustrated in FIG. 4.

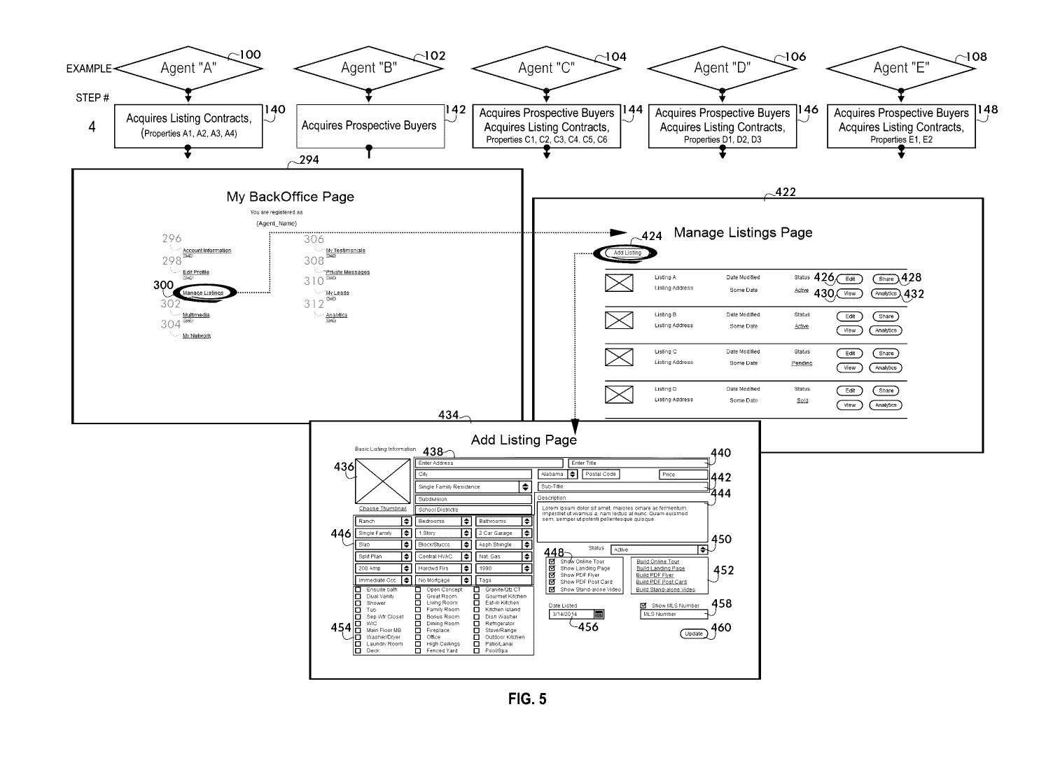

140, 142, 144, 146, 148 indicate Step 4, the necessary activities of acquiring Property Listing Contracts and developing a viable Customer Base of potential Buyers. In the illustration, hypothetical Agent “A” acquires four Listing Contracts (with the acquired Listings designated as “A1, A2, A3, & A4”) 140. Agent “B” focuses on acquiring Prospective Buyers but secures no Listing Contracts during this period 142. Agent “C” acquires six Listing Contracts (with the acquired Listings designated as “C1, C2, C3, C4, C5, & C6”) 144. Agent “D” acquires three Listing Contracts (with the acquired Listings designated as “D1, D2, & D3”) 146. Agent “E” acquires two Listing Contracts (with the acquired Listings designated as “E1 & E2”) 148. This step is more fully illustrated in FIG. 5.

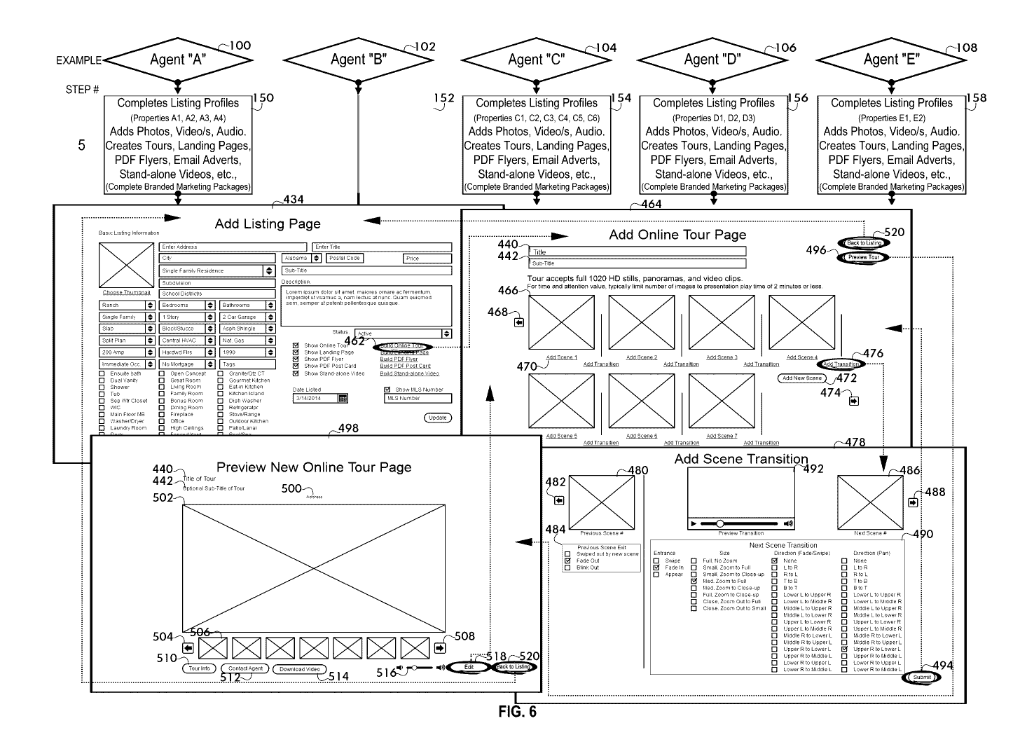

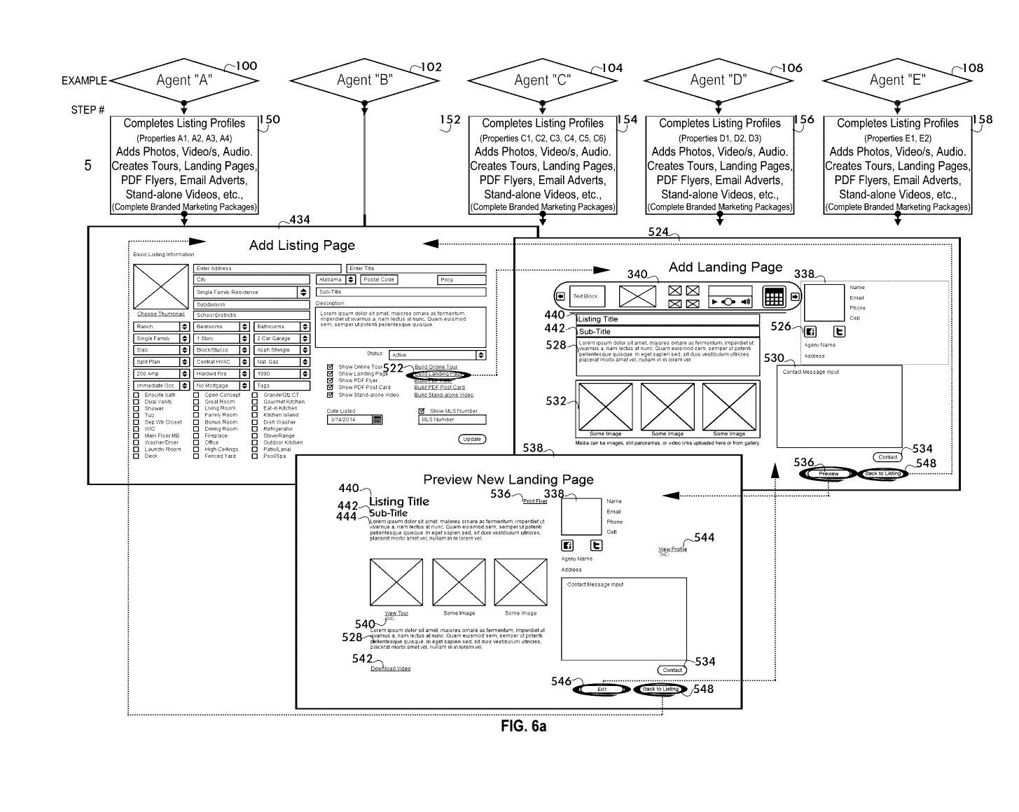

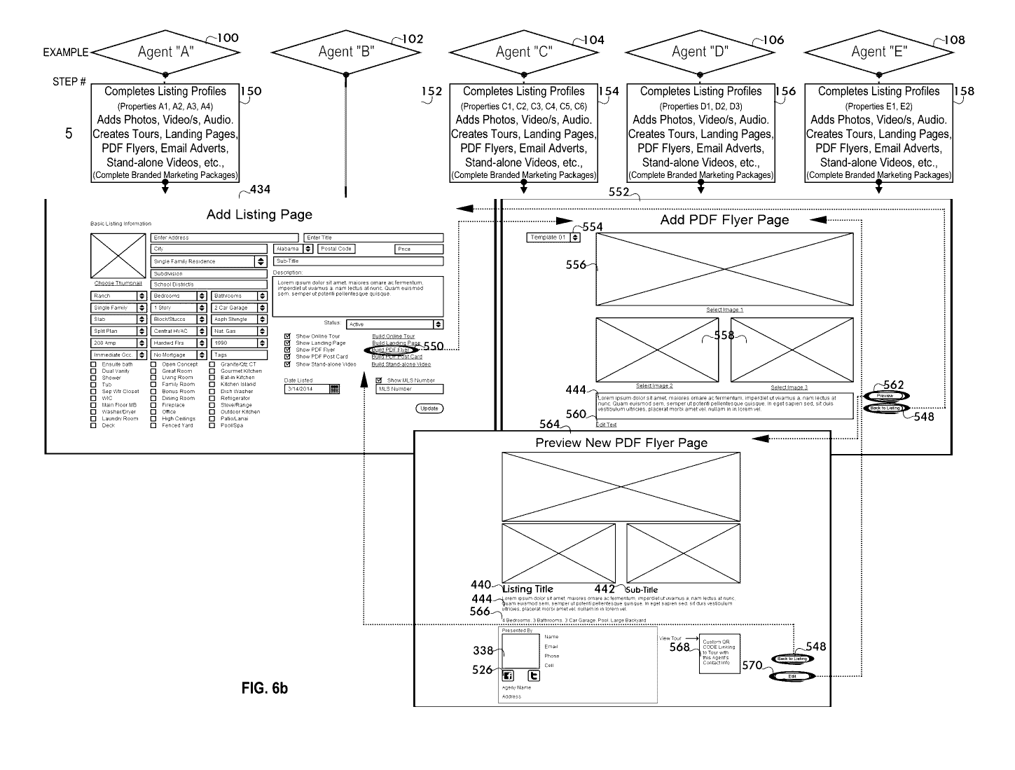

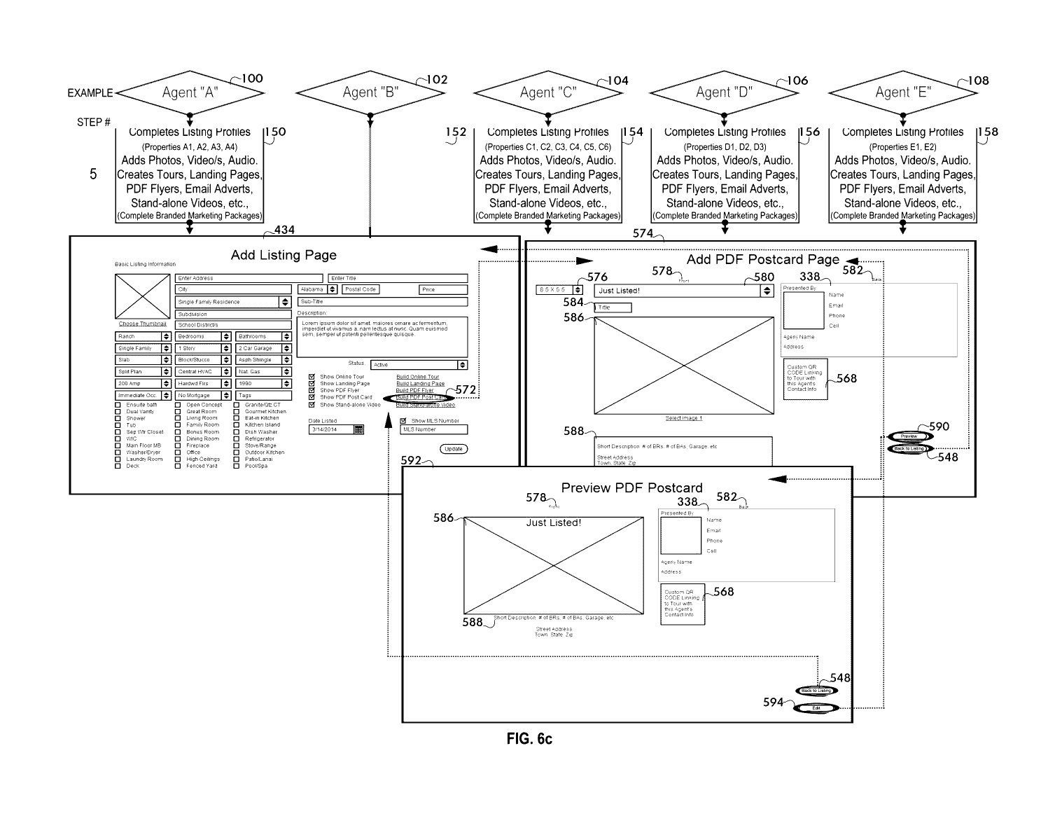

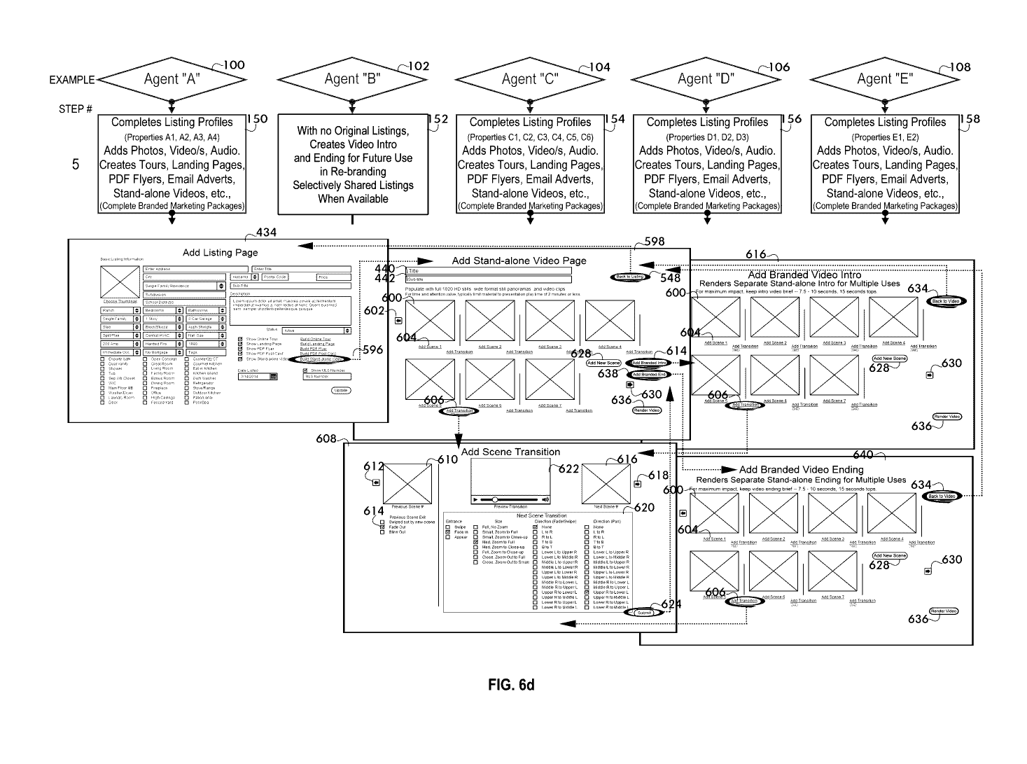

150, 152, 154, 156, 158 indicate Step 5, the necessary activities of completing the individually unique Branded Listing Profiles for each of the original Property Listings acquired by the hypothetical Agents “A” 150, “C” 154, “D” 156, and “E” 158. This includes adding multi-media such as still image photos and illustrations, panoramas, video clips, and audio content for creating Virtual Tours, Landing Pages, PDF Flyers, PDF Post Cards, Stand-alone Videos, and Email Adverts. (Agent “B” with no Original Listings has virtually no activity for this step 152.) These activities are more fully illustrated by FIGS. 6-6D.

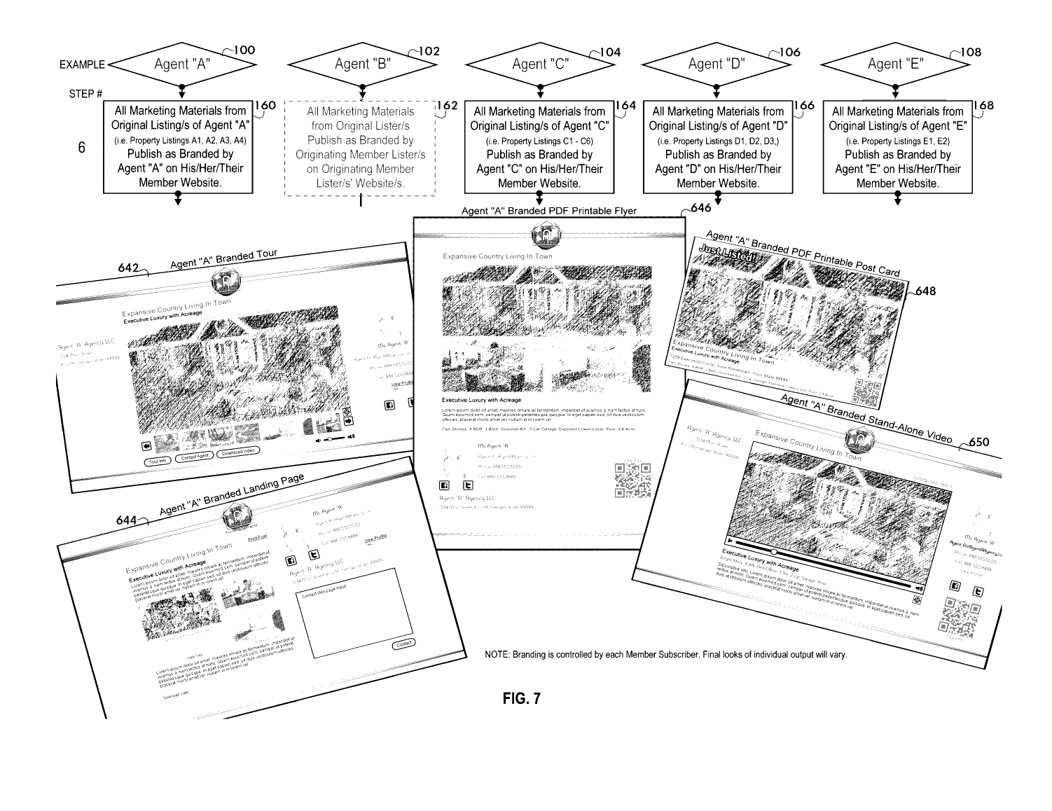

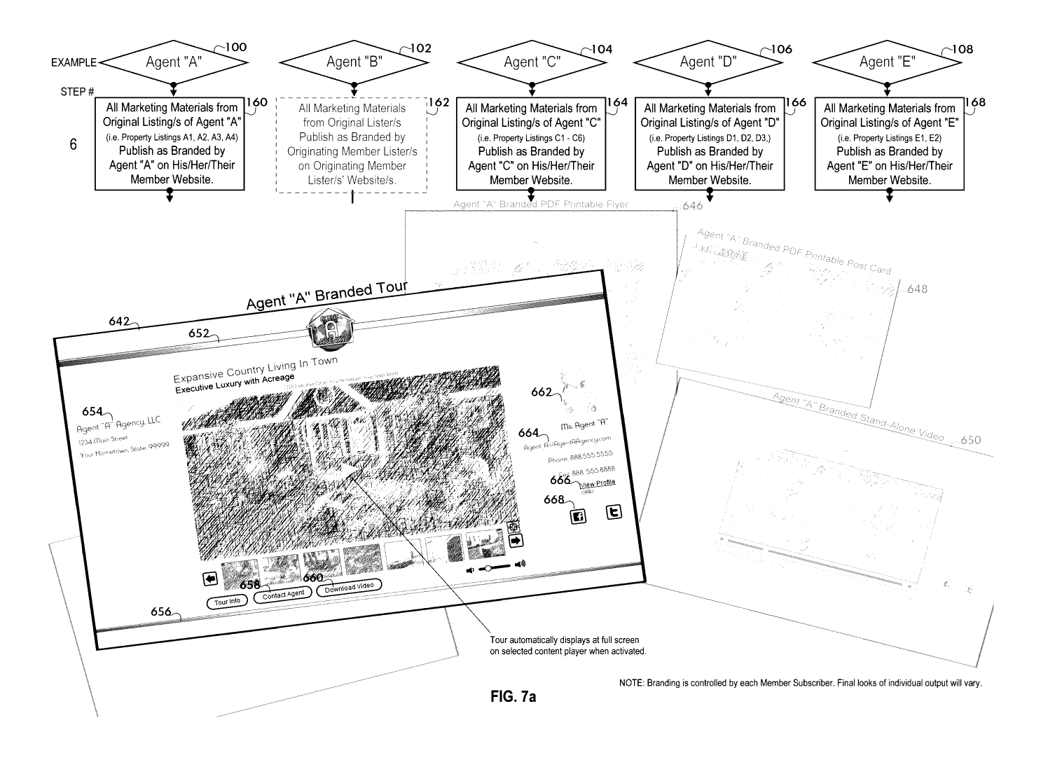

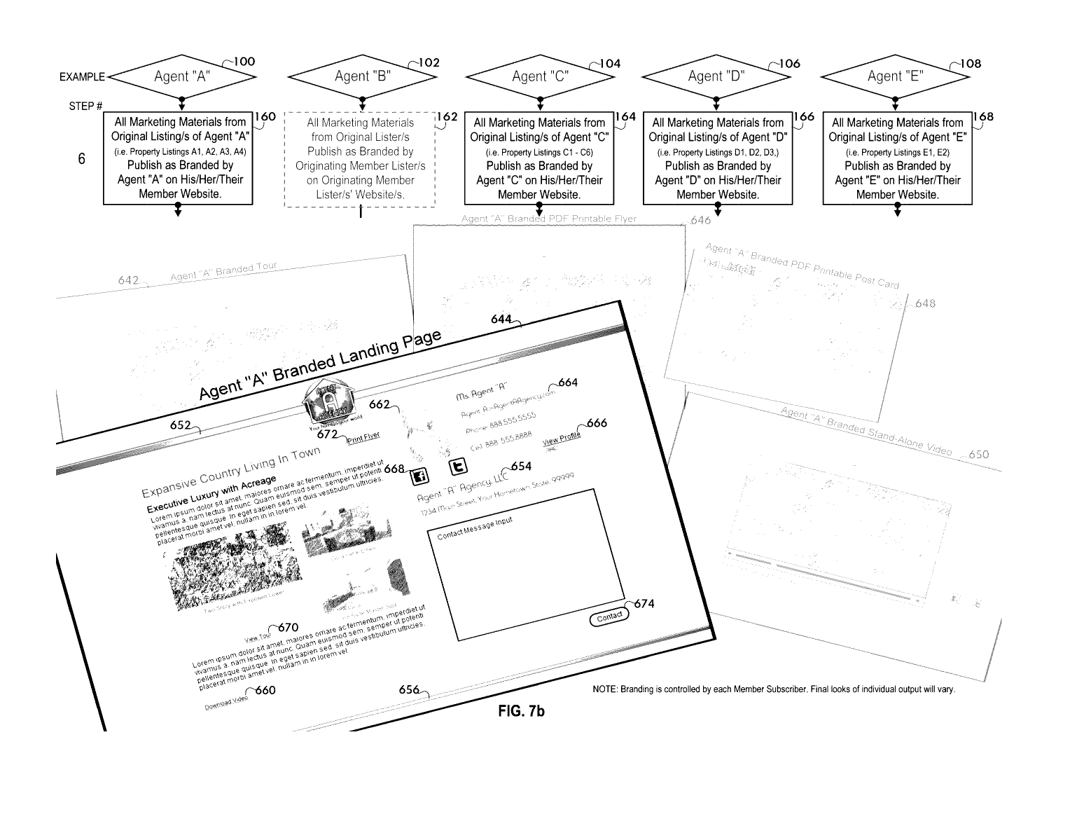

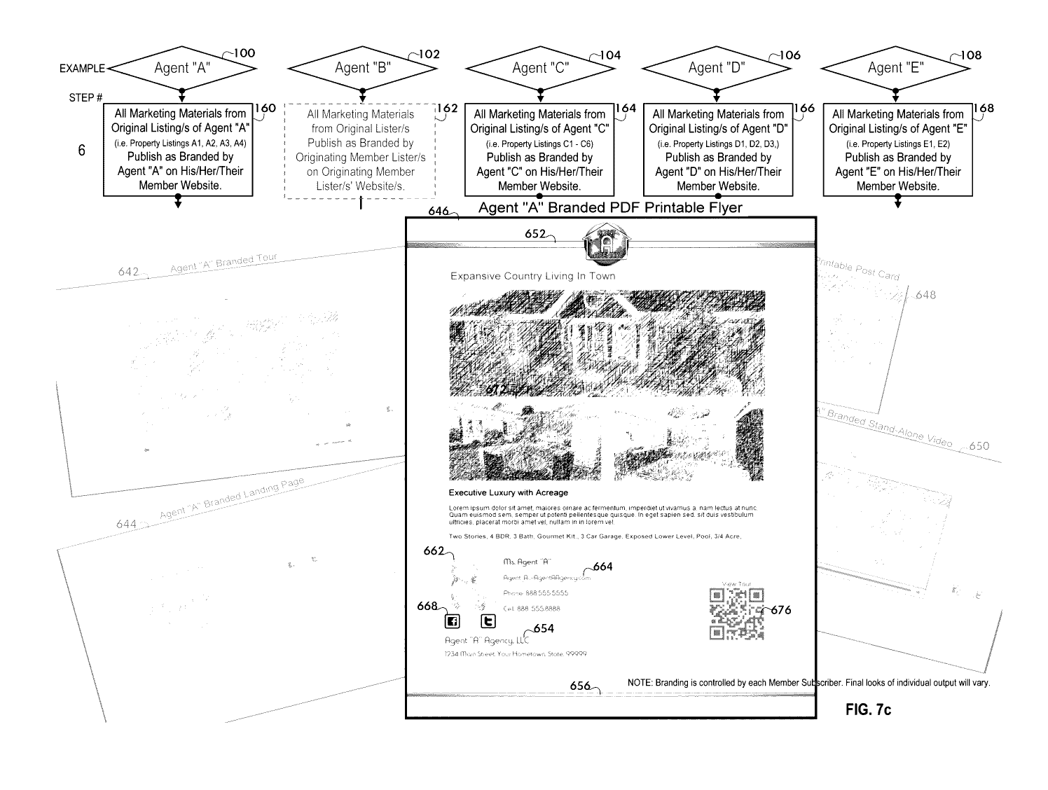

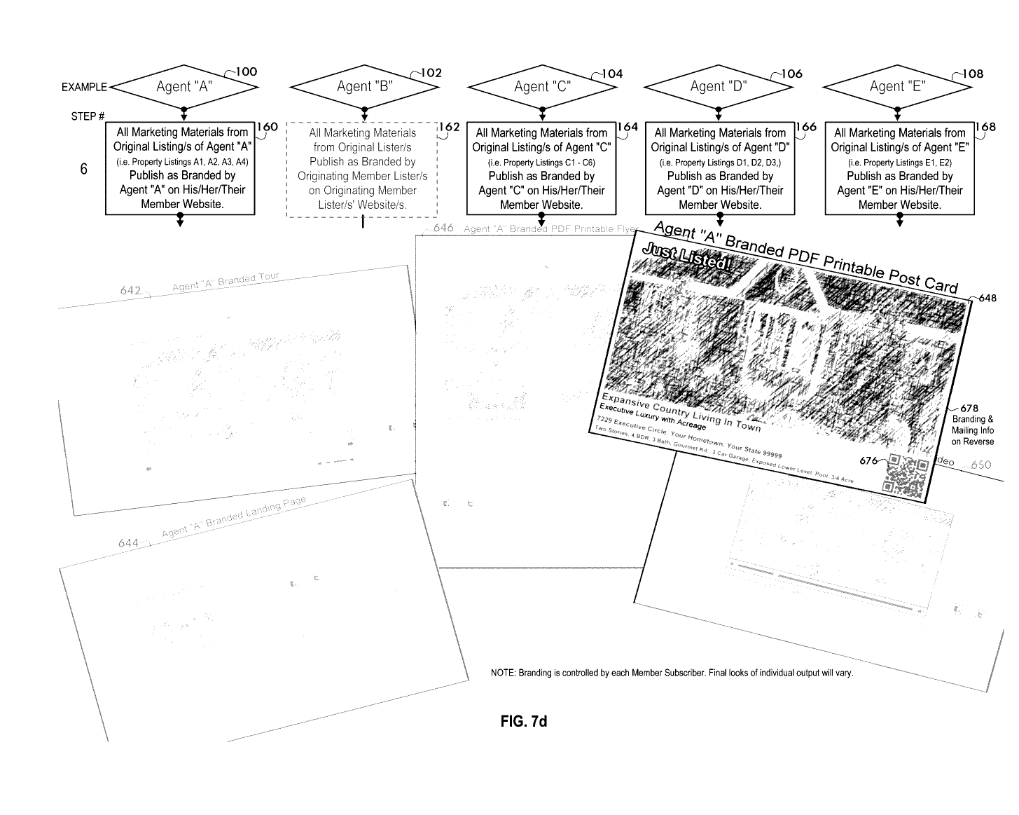

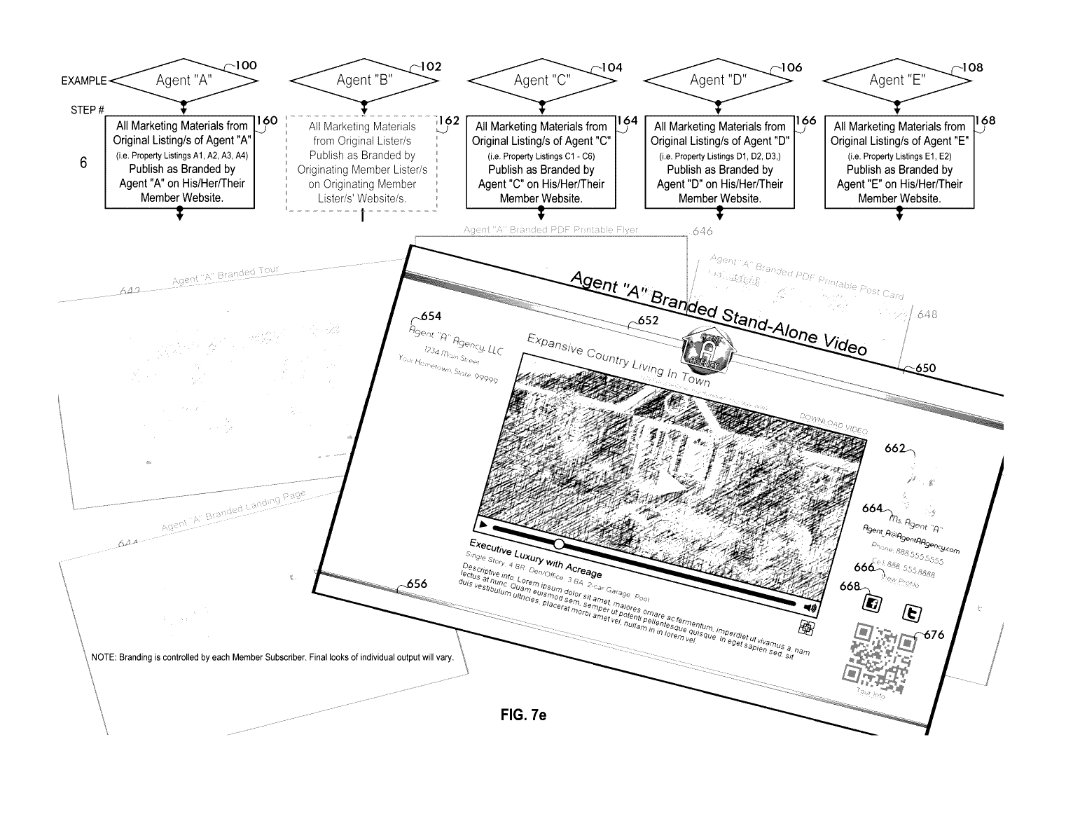

160, 162, 164, 166, 168 indicate Step 6, where the previous activities (150, 152, 154, 156, 158) result in uniquely Branded Listings when published by the Original Listing Agents as represented by the hypothetical Agents “A” 160, “C” 164, “D” 166, and “E” 168. (Agent “B” with no Original Listings has no Branded Products to show at this point 162.) The resulting Branded Products are more fully illustrated by FIGS. 7-7E.

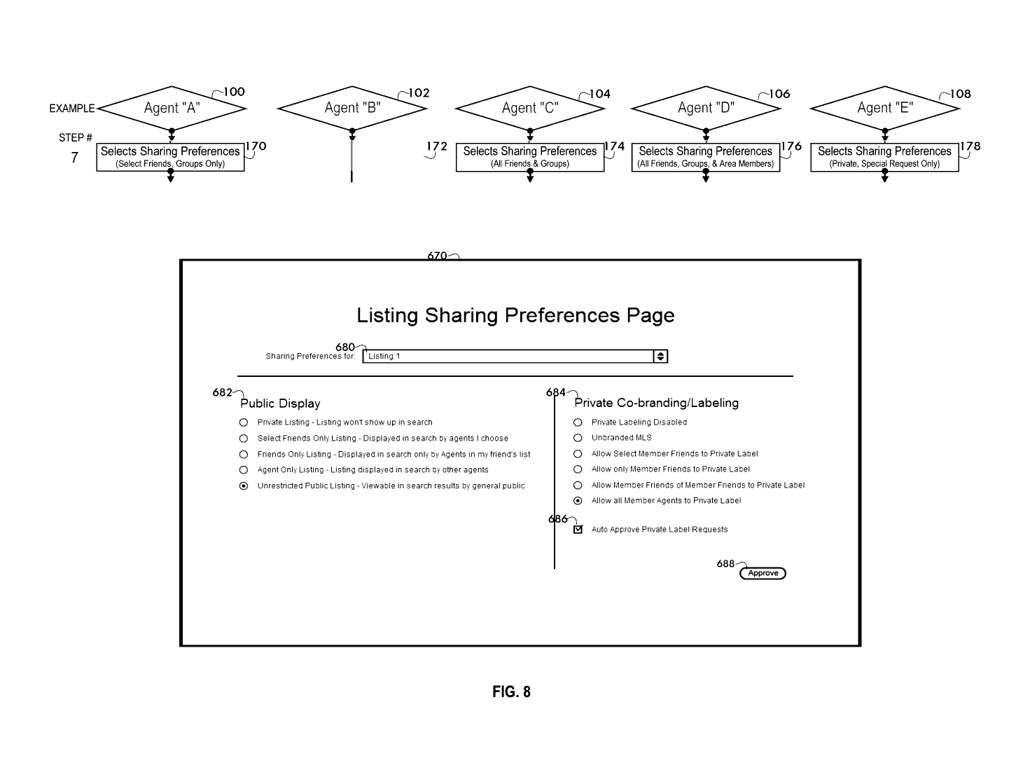

170, 172, 174, 176, 178 represent Step 7 and begin to illustrate what is so remarkably unique about the present invention. While the branding of Marketing Materials for property listings per se is not uncommon, the ability to selectively and purposely share those listings and materials with other professionals—where those listings and materials, especially in the form of Virtual Tours and Stand-alone Videos, can be custom RE-branded and made specific to a receiving professional—IS unique and is represented by the hypothetical Agents “A” 170, “C” 174, “D” 176, and “E” 178 choosing the preferences that will govern the sharing activities having to do with each of their originally Listed and Branded Property Listings. (Agent “B” with no original Listings has no activities germane to this function 172.) The Sharing Preferences selection is more fully illustrated in FIG. 8.

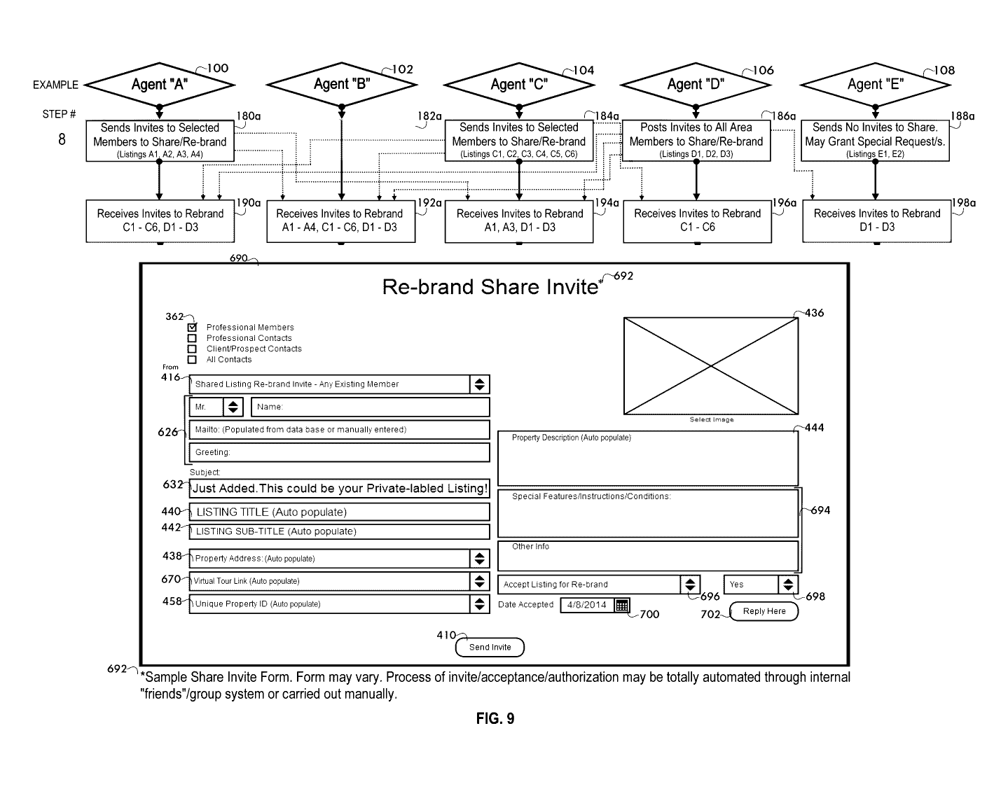

180, 182, 184, 186, 188 illustrate various scenarios (Step 8), relative to the exclusive selective sharing of Branded Property Listings as is unique to the present invention. Hypothetical Agent “A” sends Invitations to Share/Re-brand Agent “A” Original Listings “A1, A2, A3, & A4” 180 to selected Member Subscribers, Agents “B” 192 and “C” 194. Hypothetical Agent “B”, with no Original Listings, has no invitations to send 182. Hypothetical Agent “C” sends Invitations to Share/Re-brand Agent “C” Original Listings “C1, C2, C3, C4, C5, & C6” 183 to selected Member Subscribers, Agents “A” 190, “B” 192, and “D” 196. Hypothetical Agent “D” sends Invitations to Share/Re-brand Agent “D” Original Listings “D1, D2, & D3” to selected Member Subscribers Agents “A” 190, “B” 192, “C” 194, and “E” 198. Agent “E” sends no invitations to share/re-brand Agent “E” original Listings “E1 & E2”, while remaining potentially open to specific requests for sharing. The selective sending of invitations to share Listings is more fully illustrated in FIG. 9.

190, 192, 194, 196, 198 illustrate various scenarios (Step 9) relative to the unique selective receiving and accepting of shared Branded Property Listings as is unique to the present invention. Hypothetical Agent “A” receives Invitations to Share/Re-brand Agent “C” Original Listings “C1, C2, C3, C4, C5, & C6” along with Invitations to Share/Re-brand Agent “D” original Listings “D1, D2, & D3”, and, of those, accepts “C1, C2, & C4”, and “D1, D2, & D3” 190.

Hypothetical Agent “B” receives Invitations to Share/Re-brand Agent “A” original Listings “A1, A2, A3, & A4”, Agent “C” original Listings “C1, C2, C3, C4, C5, & C6”, and Agent “D” original Listings “D1, D2, & D3” and accepts all of them for Sharing/Re-branding 192.

Hypothetical Agent “C” receives Invitations to Share/Re-brand Agent “A” original Listings “A1, A2, A3, & A4”, and Agent “D” original Listings “D1, D2, & D3”, accepting of those “A1 & A3”, and “D1-D3” for Sharing/Re-branding 194.

Hypothetical Agent “D” receives Invitations to Share/Re-brand Agent “C” original Listings “C1, C2, C3, C4, C5, & C6” and accepts all of them for Sharing/Re-branding 196.

Hypothetical Agent “E” receives Invitations to Share/Re-brand Agent “D” original Listings “D1, D2, & D3”, accepting all of them for Sharing/Rebranding 198.

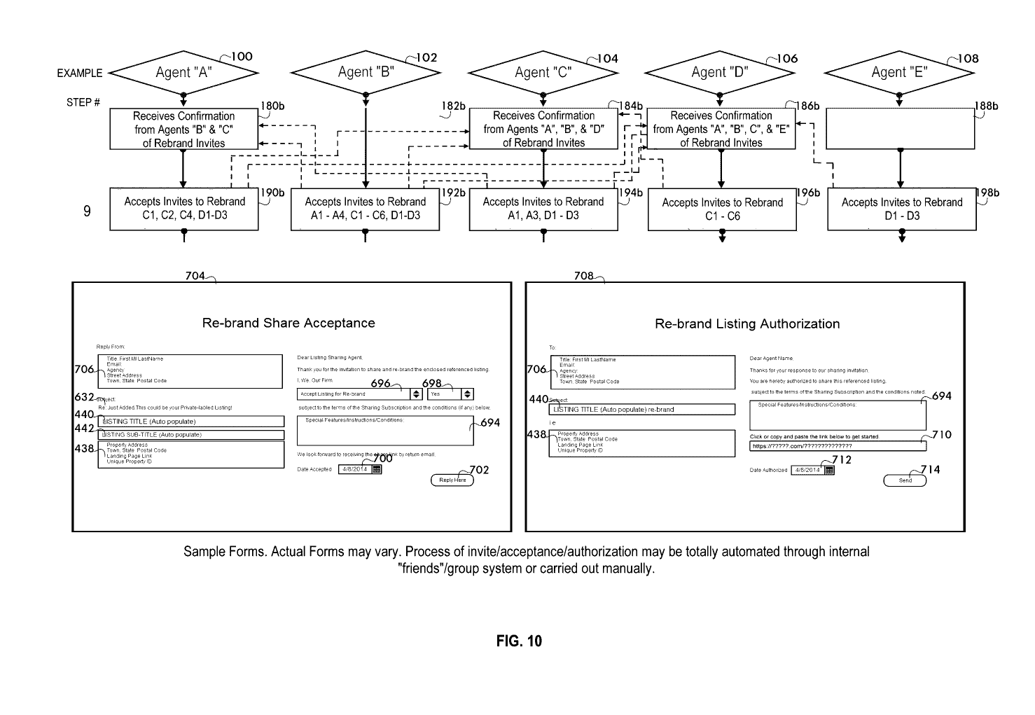

The selective accepting of invitations to Share Listings is more fully illustrated in FIG. 10.

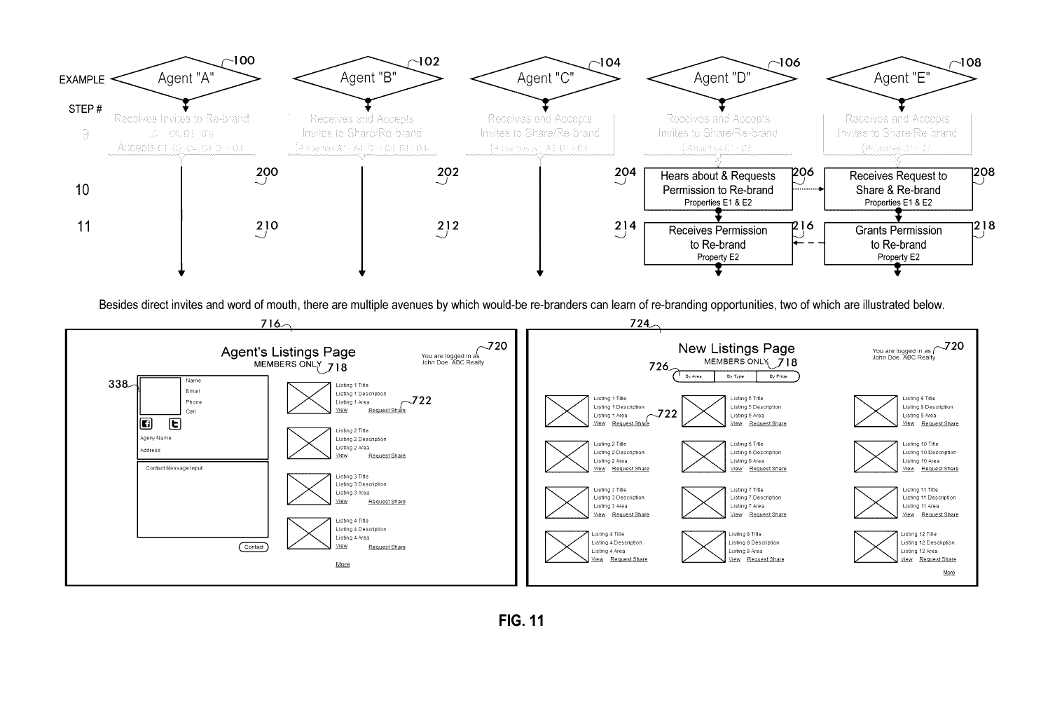

200, 202, 204, 206, 208 illustrate Step 10, a scenario where the present invention further allows selective sharing of Branded Property Listings outside of the proactive “Invitation to Share”. Agents “A”, “B”, and “C”, not being party to this exchange, are silent 200, 202, 204. Hypothetical Agent “D” hears about Original Listings belonging to Agent “E” and sends a Request for Permission to Share and Re-brand Listings “E1 & E2” 206, which request is received by Agent “E” 208. This initial exchange is more fully illustrated in FIG. 11.

210, 212, 214, 216, 218 illustrate Step 11, the continuation of the previous scenario where the present invention further allows selective sharing of Branded Property Listings outside of the proactive Invitation to Share. Agents “A”, “B”, and “C”, not being party to this exchange, are silent 210, 212, 214. Agent “E” grants Permission to Share/Re-brand Property Listing “E2” 218 (while Agent “E” retains privacy for Original Listing “E1”), and the Shared Listing “E2” is received and accepted by Agent “D” 216. This completed exchange is more fully illustrated in FIG. 11.

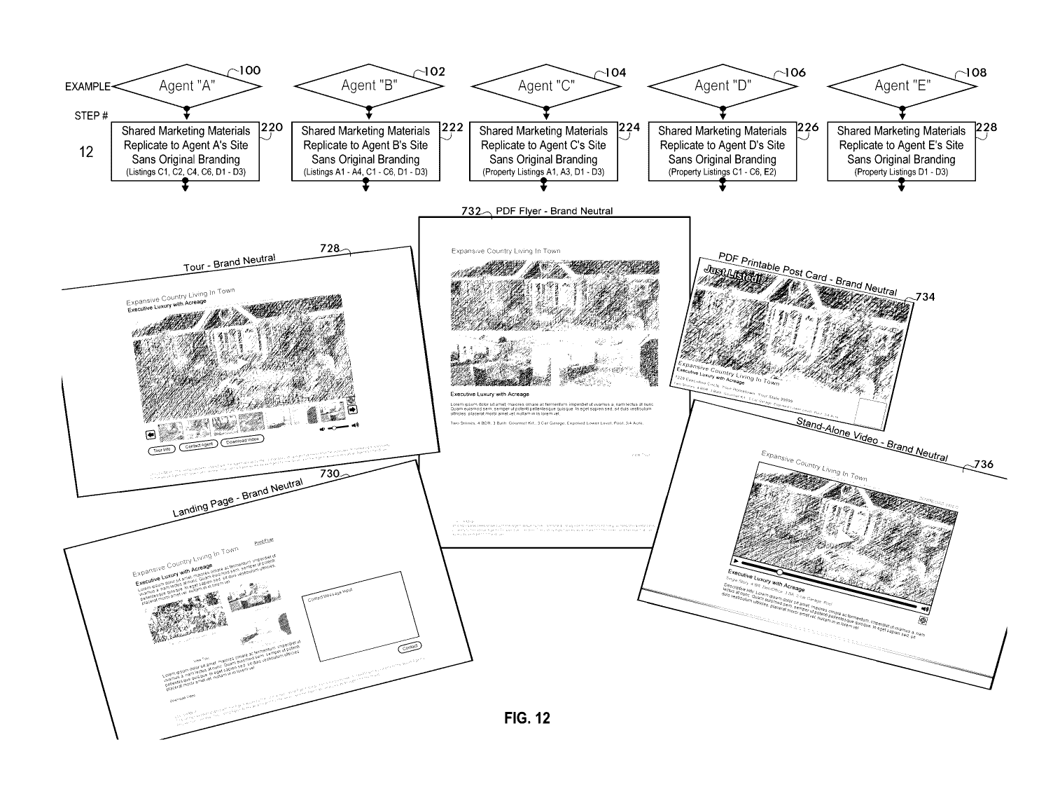

220, 222, 224, 226, 228 illustrate Step 12, the process whereby the Custom Branding of the system-generated Marketing Materials from the Original Listings is stripped away from the Originally Branded Listing Materials by the present invention for purposes of replicating and forwarding those materials to the selected recipients for Sharing/Re-branding. Agent “A” receives neutrally branded materials for Listings “C1, C2, C4, C6”, and “D1-D3” 220. Agent “B” receives neutrally branded materials for Listings “A1-A4”, “C1-C6”, and “D1-D3” 222. Agent “C” receives neutrally branded materials for Listings “A1 & A3” and “D1-D3” 224. Agent “D” receives neutrally branded materials for Listings “C1-C6”, and “E2” 226. Agent “E” receives neutrally branded materials for Listings “D1-D3” 228. This completed exchange is more fully illustrated in FIG. 12.

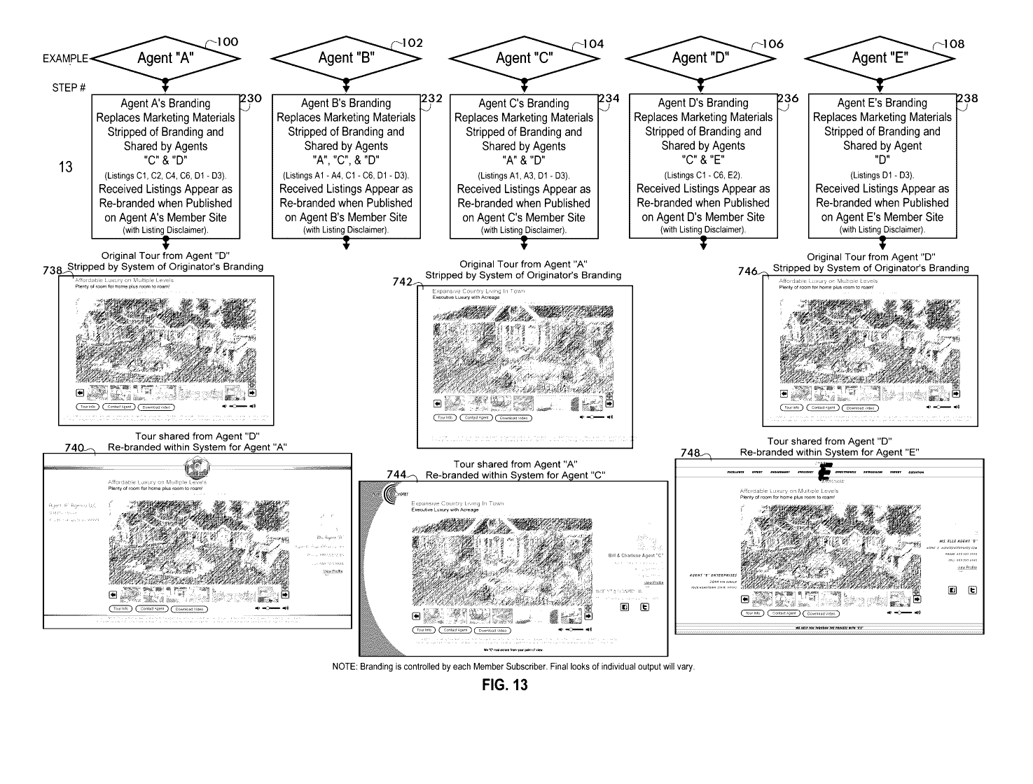

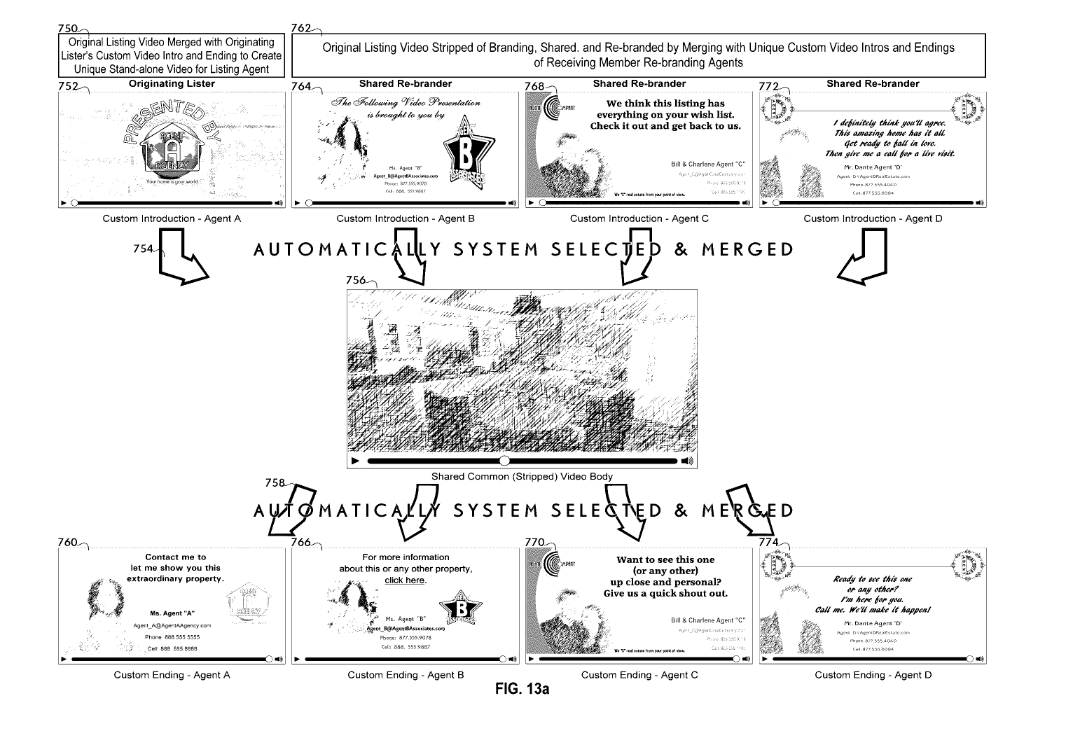

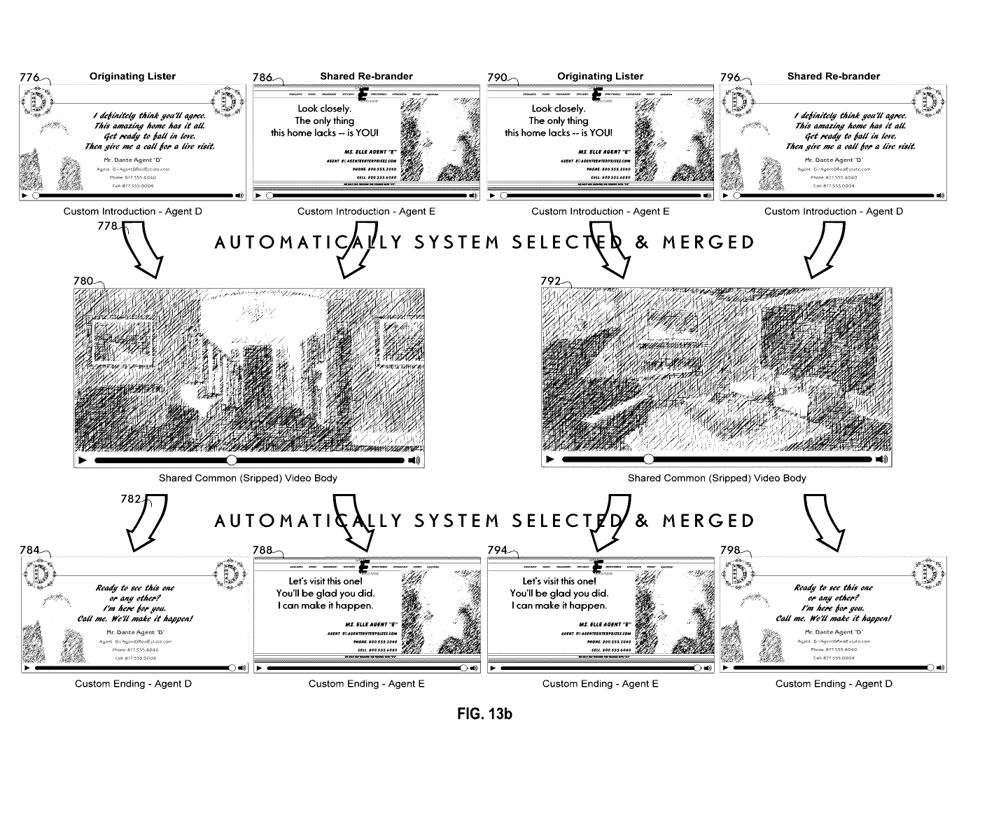

230, 232, 234, 236, 238 illustrate Step 13, the process whereby Marketing Materials for Original Listings, their brandings having been removed by the present invention, have the Original Brandings replaced by the recipients' own Custom Branding. Custom Branding for Agent “A” is added to the neutrally branded materials for Listings “C1, C2, C4, & C6”, and “D1-D3” 230. Custom Branding for Agent “B” is added to the neutrally branded materials for Listings “A1-A4”, “C1-C6”, and “D1-D3” 232. Custom Branding for Agent “C” is added to the neutrally branded materials for Listings “A1 & A3”, and “D1-D3” 234. Custom Branding for Agent “D” is added to the neutrally branded materials for Listings “C1-C6”, and “E2” 236. Custom Branding for Agent “E” is added to the neutrally branded materials for Listings “D1-D3” 238. This completed exchange is more fully illustrated in FIGS. 13-13B.

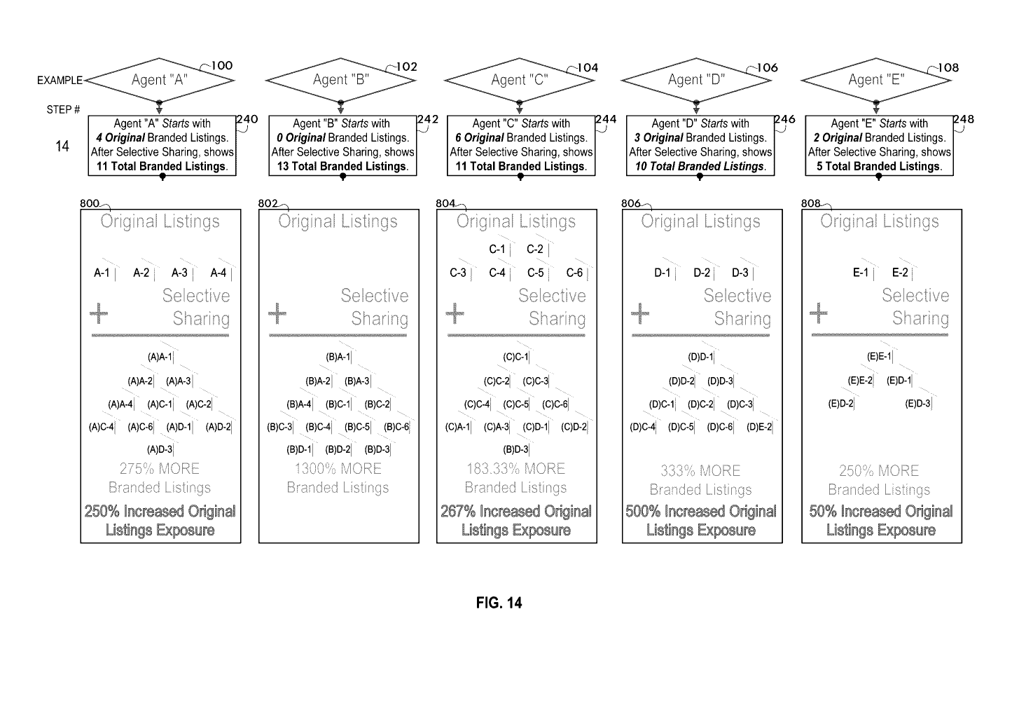

240, 242, 244, 246, 248 illustrate Step 14, the potential increase that Member Subscribers might enjoy in the number of Branded/Re-branded Listings they can provide on their respective Subscription Websites for marketing to their clientele. Having received the Selectively Shared Listings of “C1, C2, C4, & C6”, and “D1-D3”, hypothetical Agent “A” grows the number of branded Listings from her original four (4) to a total of eleven (11) 240. Agent “B”, who started with zero (0) Original Listings, now shows thirteen (13) 242. The Agent “C” team grows from six (6) Original Listings to eleven (11) 244. Agent “D” with three (3) Original Listings now boasts 10 total Branded/Re-branded Listings 246. And even Agent “E”, who started with two (2) Original Listings, now offers five (5) 248. This is more graphically illustrated in FIG. 14.

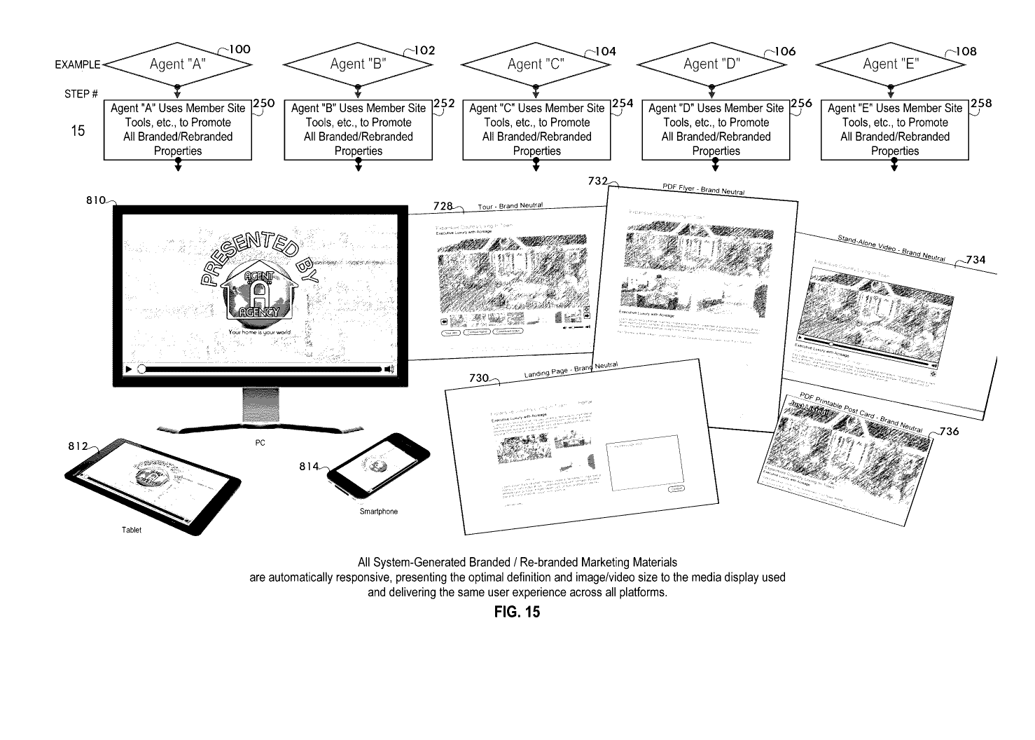

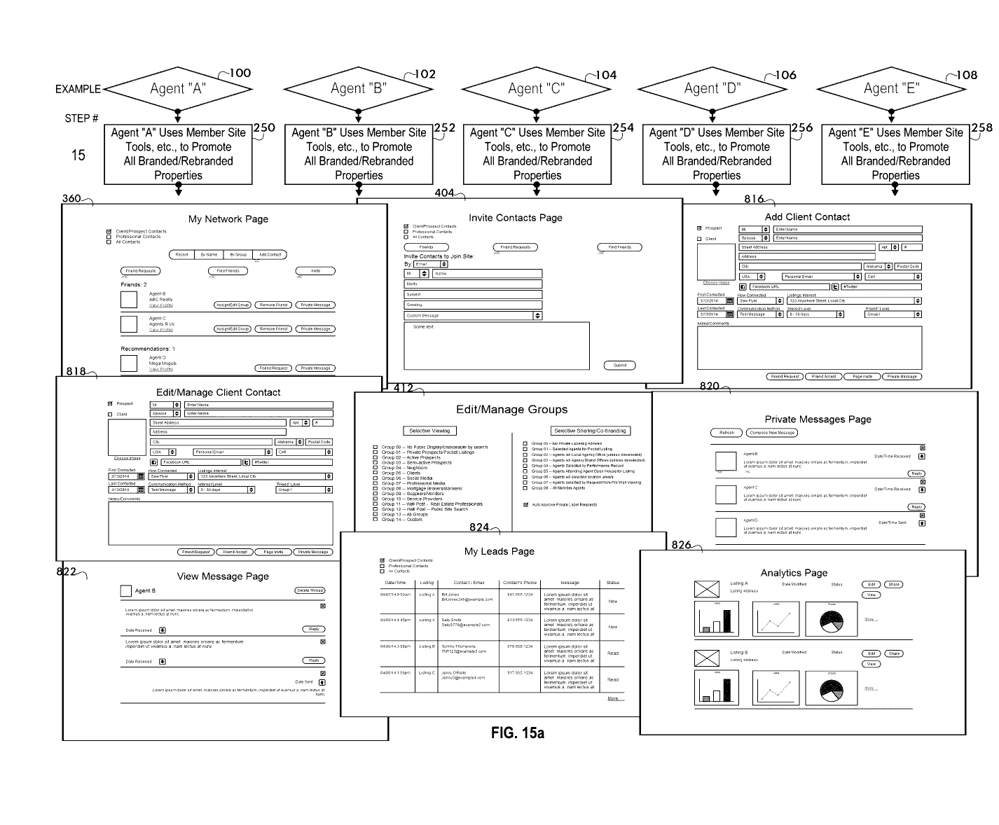

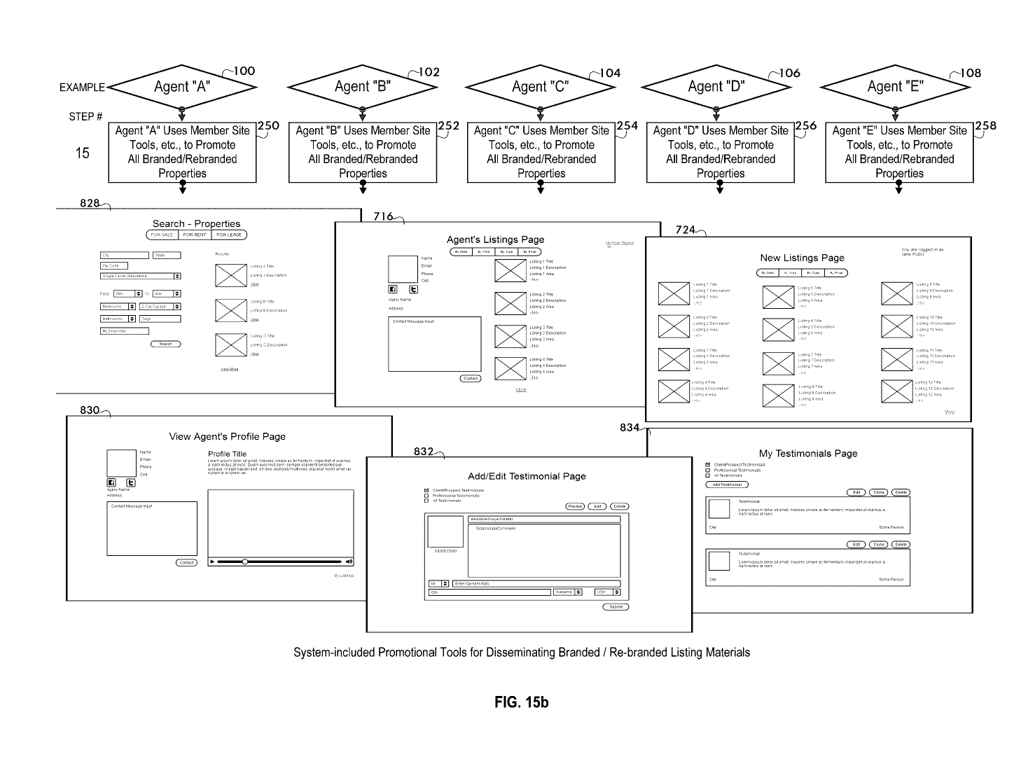

250, 252, 254, 256, 258 illustrate Step 15, the use of the present invention's Member Site tools for promoting Branded/Re-branded Property Listings. This functionality is more fully illustrated in FIGS. 15-15B.

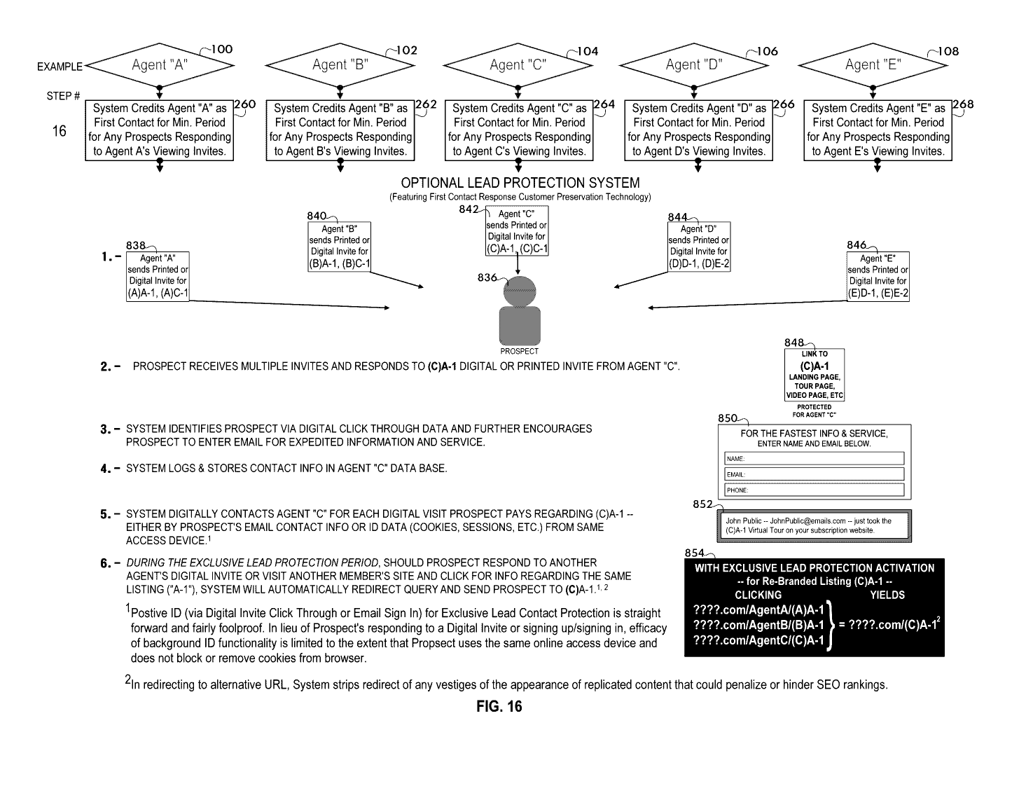

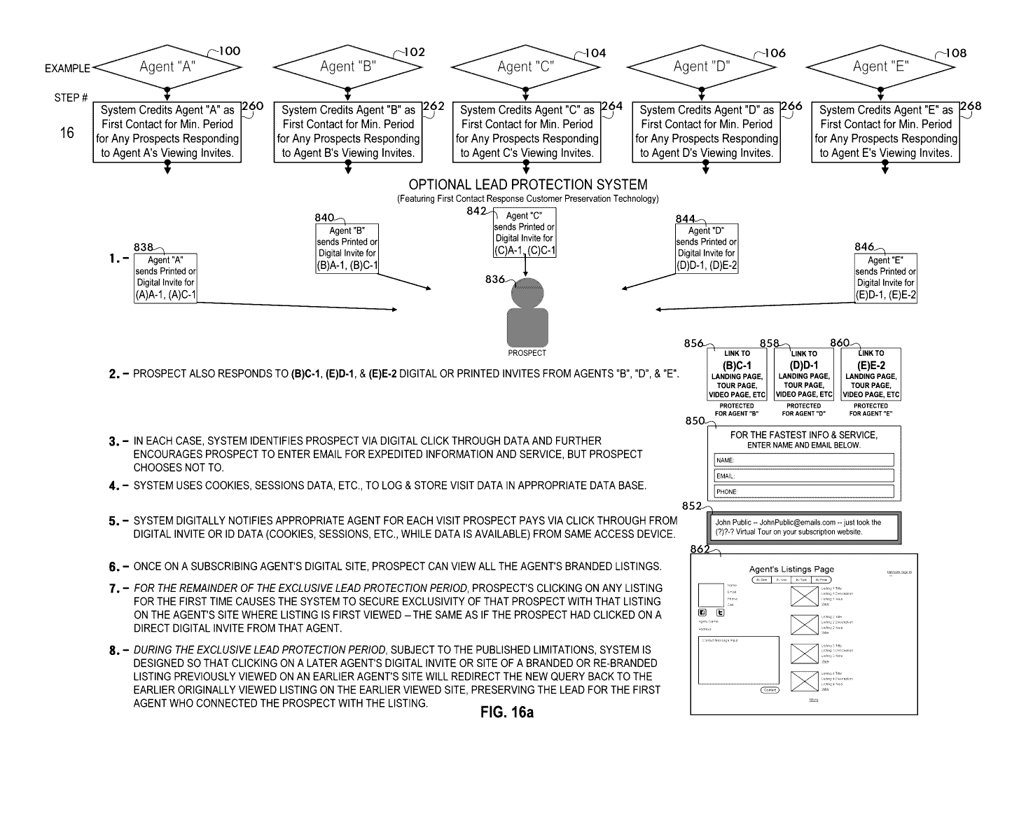

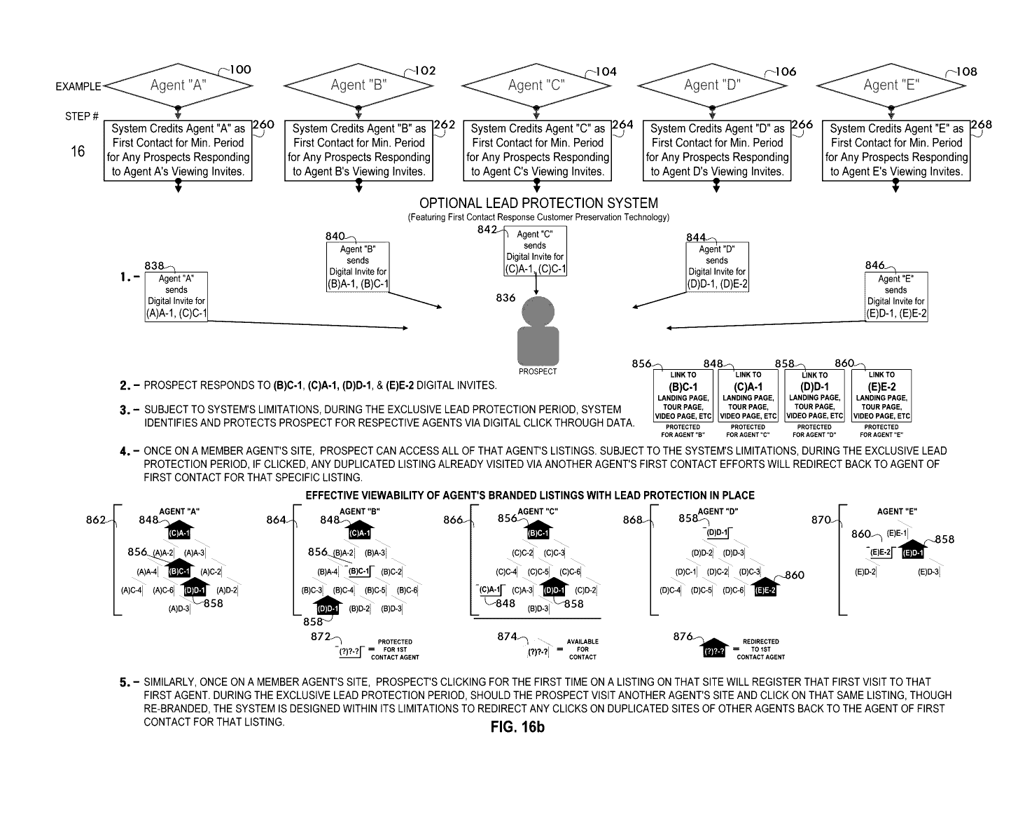

260, 262, 264, 266, 268 illustrate Step 16, the use of the present invention's optional ability (with certain limitations) to preserve the integrity of leads based upon first contact response resulting from a Member Subscriber's marketing efforts regarding a particular Branded/Re-branded Property Listing. This functionality is more fully illustrated in FIGS. 16-16B.

270, 272, 274, 276, 278 (Step 17) recognize that the present invention is a lead generation and enhancement tool that in no way interferes with the normal or contracted commission structure in place to be respected and observed between Member Subscribers where Original Listings are selectively Shared and Re-branded and sold to the Re-branding Agent's Customers.

FIG. 2 (“Step 1”) illustrates the sign up or sign in procedure by which new or existing Member Subscribers (such as hypothetical Agents “A” through “E”) access or re-access the online Member Subscription service of the present invention 110-118. 280 represents the home page where a Prospective Member could click on a “Sign Up” link 282 and be taken to a Create Account page 286 to begin providing contact information to establish a new subscription account. Clicking either the “Billing Information” 286 or “Submit” buttons 288 opens the (sample) Billing Information window 290 for collecting the necessary data for a recurring online credit card subscription transaction. Clicking “Submit” 292 on that page finalizes the transaction (including acceptance of Privacy Policy and Terms of Service—not necessary to be shown for the present purposes) and takes the new Member Subscriber to the Sign In Page 316.

The home page 280 is also where an existing Member Subscriber can click on “Sign In” 314 and be taken to the sign in page 316 to provide their email or Member Name and Password, click “Sign In” 318 to be taken to the BackOffice Page 294. Provision is made 320 to 324 and 326 to retrieve a forgotten Password as well as a “Need an Account” redirect 322 if the sign in page was inadvertently accessed by a non-member.

Once on the “My BackOffice Page” 294, Member Subscribers can access their Account Information 296, Edit their Profile 298—FIG. 3 328, Manage their Listings 300—FIGS. 5-15, access their Multimedia 302 (not necessary to be illustrated), expand or contact their Network 304—FIG. 4 360, edit their Testimonials 306—FIG. 15B 820, manage their Leads 310—FIGS. 16, 16A, 16B, and review their Analytics 312—FIG. 15A 810.

FIG. 3 (“Step 2”) illustrates the steps Member Subscribers (Agents “A”-“E”—120, 122, 124, 126, 128) use to access 296 (“Account Information”) or 298 (“Edit Profile”) and build and edit their online Agent Profiles 328. Available tools include the ability to add or select a Profile Photo 330, update all their Contact Information 332, and click 334 to access their “Advanced Edit Profile Page” 336. A condensed Profile Grid 338 (populated from previously input data) displays. This is the same Profile Grid that will appear on numerous pages throughout the Member Subscribers' sites. A suite of drag and drop editing tools 340 allows easy building and editing of their Profiles, even from mobile phones and tablets. Provision is made for specific titling 342, marketing messaging 344, email contact 346, personally customized video inclusion 348, and captioning of multimedia 350. Clicking “Update” 352 submits the data from the page and takes Member Subscribers to “Preview Edit Profile Page” 354 where they can view their work as it will appear when published. They can also edit the action of the “Contact” button 354 that Prospects will use in seeking information from the Agents.

FIG. 4 (“Step 3”) illustrates the important steps whereby Member Subscribers begin to establish online friendship and networking connections with other Member Subscribers (i.e., Agents “A”-“E”—130, 132, 134, 136, 138) in order to involve other Member Subscribers in the joint marketing efforts of goods and services—a/k/a “Property Listings”—they may each mutually offer to their own unique Prospects and Customers.

From “My BackOffice Page” 294, clicking 304 takes a Member Subscriber to “My Network Page” 360. Clicking the appropriate box or button 362 chooses the category of contacts to be displayed—“Client/Prospects Contacts”, “Professional Contacts”, or “All Contacts”. The list of “Friends” and Contacts” that next appears can be sorted by clicking 364 to access data by “Recent” (shown), “By Name”, “By Group”, or “Add Contact”. Friends visible from this screen can be Edited/Managed by clicking “Assign/Edit Group” 380 (more below), deleted by clicking “Remove” 382, or contacted by clicking “Private Message” 370.

Clicking 366 accesses the “Friend Requests Page” 388 to view the status of unanswered Friend Requests” which can be sorted by clicking to access data by “Recent” (shown), “By Name”, “By Group”, or “Add Contact” 364. Pending Friend Requests appear at 390 and can also be cancelled from there 392. System Recommended Friends will also display 386, offering “Friend Request” 394, “Cancel” 354, and “Private Message” 384 as options.

Clicking “Find Friends” 368 from either the “Friend Requests Page 388 or the “My Network” Page 360 yields the “Find Friends Page” 396. From this page, a Member Subscriber can “Search for Friends” 398 via Email or other filtering criteria 400 or by an alpha search 402. As with the previous “Friend Requests Page 388, the System may make Recommendations 386 which can be Requested 394, Cancelled 354, or Private Messaged 384.

Clicking “Invite” 370 from the “My Network Page” 360, or the “Friend Requests Page” 388, or the “Find Friends Page” 396 will take the Member Subscriber to the “Invite Contacts Page” 404. Activating the preference of contact type—“Client/Prospects Contacts”, “Professional Contacts”, or “All Contacts”—362 allows the generation of a Friend Invite through an interface screen 408. Clicking “Submit” 410 activates the Invitation via email or other selected means. Leaving the Invite Page is accomplished by clicking “Friends” (back to the “My Network Page” 360, or the “Friend Requests” 366 (“Find Friend Requests Page” 388), or the “Find Friends” 368 (“Find Friends Page” 396).

An important feature for the unique selective sharing function of the present invention is the ability to establish Visibility Parameters and Sharing Preferences. This functionality is available from the “My Network Page” 360 by clicking “Assign/Edit Groups” 380 which yields the “Edit/Manage Groups” screen 412. The left section of the page allows assignation of visibility for any particular Listing from choices under “Selective Viewing” 412. Sharing Parameters among professionals and Member Subscribers are established for Listings in the right hand section bearing the heading “Selective Sharing/Rebranding” 416.

An additional important parameter can be turned on or off by selecting or deselecting “Auto-Accept Private Label Requests” 418. Checking this box will see to it that any request from any Member Subscriber to Share and Re-brand a particular Listing will be accepted without any additional interaction between the Original Lister and the Shared/Re-branded Lister. Deselecting the box 418 will necessitate being in direct two-way electronic contact with any Member Subscriber wishing to share and Re-brand the particular Listing in question.

Clicking “Accept” on this page 412 will navigate back to the “My Network Page” 360.

FIG. 5 (“Step 4”) represents the initial steps necessary to load a new Listing into a Member Subscriber's inventory data base. From the “My BackOffice Page” 294, clicking “Manage Listings” 300 will open the “Manage Listings Page” 422. All current listings load into the inventory listing in the default sort mode of newest at the top. From this page, Listings show by “Title” or other heading, “Address”, “Date Modified”, “Entry Date”, and any other selected filters currently available or added in the future. Each Listing can be Edited 426, Shared 428, Viewed 430, and checked for Analytics 432.

The unique selective sharing power of the present invention begins to be tapped by clicking the “Add Listing” button 424 which opens the “Add Listing Page” 434—the virtual “Control Panel” for online promotion of Property Listings in ways that have never been available to real estate professionals before.

A representative photo is picked from the gallery or directly uploaded and turned into a thumbnail 436 for instant listing identification. While numerous other images can be associated with the Property, it is this one that becomes the easily recognized “logo” for the Listing.

438 is to be populated with the most basic of identifying information regarding the Listing. The “Title” 440 to be entered is also quite important, as it will also be used as a “universal identifier” throughout the system-generated Marketing Materials for the Property. Similarly, 442 is set aside for a “Sub-title” for the same purpose. 444 is a section devoted to descriptive language that will be used on much of the other Marketing Materials. An additional range of descriptive items can be accessed from the drop down menus in the section indicated by 446 which call out some of the more common features of houses for sale or rent. Clicking boxes in section 454 further helps define and refine the Marketing Materials.

The Listing's “Status” (“Active”, “Pending”, Under Contract”, etc.) is indicated at 450.

Specific marketing output to be shown or not is selected by clicking the boxes or buttons at 448. Links to building the related system-generated marketing items (such as the “Online [Virtual] Tour”, the Online and email-able “Landing Page”, the PDF Flyer, the PDF Post Card, and the “Standalone Video”) are selectable at 452.

A drop-down calendar is offered to enter the Listing Date 456, and a place to enter and allow or disallow posting the MLS number is also provided 458. Clicking “Update” 460 stores the entered fields in the online data base.

FIG. 6 (“Step 5”) illustrates the process of building an online Virtual Tour of a Property Listing. This Virtual Tour can be shared with and re-branded by other Member Subscribers for marketing to their respective Prospects and Customers. While the totality of the features offered by the system raise the present invention above the realm of present art, the unique ability to brand and post a Virtual Tour (and/or a Standalone Video) which can be selectively shared and re-branded for another Member Subscriber is its most salient and patentable feature.

150, 152, 154, 156, 158 indicate the necessary activities of completing the individually unique Branded Listing Profiles for each of the original Property Listings acquired by the hypothetical Agents “A” 150, “C” 154, “D” 156, and “E” 158.

More specifically, from the “Add Listing Page” 434, clicking “Build Online Tour” 462 opens the “Add Online Tour Page” 464. The previously added “Title” auto-populates in section 440 as does the “Sub-title” in section 442. A successful Virtual Tour uses carefully selected multi-media, chosen and uploaded by the Member Subscriber, to tell the sales story of the Property being presented. 466 draws attention to the types of material the system is designed to use in presenting a successful Tour, such as full 1020 HD still images, still and active panoramas, and video clips. Audio clips for background sound and narration can also be uploaded. Any visual element added represents a “Scene” 470. Additional Scenes can be made available beyond the Scene spaces already provided by clicking 472, and scrolling between currently visible and previous or later scenes is accomplished by clicking 468 and 474 respectively.

The manner in which one Scene follows or flows into the next is referred to as a “Transition” which can be added concurrently with the addition of a Scene or at any other time after, including after all graphical elements are in place. Clicking 476 starts the “Add Transition” process by opening the “Add Scene Transition” page 478. 480 indicates the “Previous Scene” at the point of a Transition insertion and 486 indicates the Scene that follows. Scrolling between Scenes and Transitions is accomplished by clicking 472 for “Previous” and 488 for “Next”. 484 and 490 call attention to the types of Transitions that might be available or appropriate between Scenes, and 492 indicates a Viewer that allows the auditing of any particular Scene to Scene Transition. Clicking “Submit” 494 locks the Transition in place and sends the process back to the “Add Online Tour Page” 464 unless the Transition is further edited then or at a later time.

At any time during the process or at the end, clicking 496 allows for the Previewing of the Virtual Tour by taking the Member Subscriber to the “Preview New Online Tour Page” 498. On that page, the Title 440 and Sub-title 442 appear together with the Address 500.

Under the Viewing Window 502 is a row of Thumbnail images 506, each representing a Scene from the Tour. Highlighting any one of the Thumbnails causes the larger version of that image to be shown in the Viewing Window 502. If there are more thumbnail images than can be viewed at one time under the Viewing Window, the string of Thumbnails will scroll automatically while the Tour plays or can be scrolled manually left and right by clicking the indicated arrows 504 and 508.

Under the row of Thumbnail images, “Tour Info” 510 is accessible with a click. Next to that button, clicking “Contact Agent” 512 will put a viewer in email contact with the Agent as well as provide a cell number for a phone call or text message. The System is designed to notify the respective Member Subscriber by email and/or text message when a contact request has been made.

Clicking “Download Video” 514 will allow an online visitor to download a Custom Branded Stand-alone Video of the Tour (if one has been provided by the originating Member Subscriber Listing Agent). Audio volume is controllable by moving the volume bar indicator at 516. If further edits are needed, clicking “Edit” 518 will send the Member Subscriber back to the “Add/Edit Online Tour Page” 464. Clicking “Back to Listing” 548 saves the data and returns the Member Subscriber to the “Add Listing Page” 434.

FIG. 6a (“Step 5”, continued) illustrates the process by which a Member Subscriber who is an Originating Lister can build an online Landing Page—a/k/a “Capture Page”—for a Property Listing which can be shared with and re-branded by other Member Subscribers for marketing to their respective Prospects and Customers.

150, 152, 154, 156, 158 indicate the necessary activities of completing the individually unique Branded Listing Profiles for each of the original Property Listings acquired by the hypothetical Agents “A” 150, “C” 154, “D” 156, and “E” 158 and are shown again by way of reference.

More specifically illustrated, from the “Add Listing Page” 434, clicking “Build Landing Page” 522 opens the “Add Landing Page” 524. A suite of drag and drop editing tools 340 is immediately available to facilitate the rapid building and editing of the Landing Page, even from mobile phones and tablets. The previously added “Title” auto-populates in section 440 as does the “Sub-title” in section 442. Below the Sub-title is a section for adding brief but specific descriptive verbiage 528 that will publish in addition to the previously loaded description 444 from the “Add Listing Page 434.

One of the purposes of a successful Landing Page is to visually attract interest, and the image section 532 allows for featuring at least three carefully selected high definition images, or a mix of images, panoramas, and Videos. (Though not graphically illustrated, the exclusive technology of the System allows for Video “teasers” or full Standalone Videos to play directly from a Landing Page, an email, or email attachment.)

The previously populated Agent Profile Matrix 338 is featured on the page with Social Media callouts 526. A dedicated “Contact Message” section 530 is provided, along with a programable “Contact” button 534, to maximize the communication power of the Landing Page. (When the Landing Page is published, a Prospect's responding to the “Contact” button will trigger an email or Text Message notification to the Member Subscriber whose site or Landing Page the Prospect is visiting.)

Clicking the “Preview” button 536 reveals the “Preview New Landing Page” 538. In addition to the features already addressed, the Preview Page (and final published Landing Page) include a live link 540 to the Virtual Tour and a link 542 for a download of any completed Custom Branded Stand-alone Video. A customer can also click a link 544 to view the published Agent's Profile.

Further editing is possible from the “Preview New Landing Page” by clicking on “Edit” 546 at the lower right to return to “Add/Edit Landing Page” 524.

Clicking “Back to Listing” from either the “Preview” or “Edit” pages will return the Member Subscriber to the “Add Listing Page” 434.

FIG. 6b (“Step 5”, continued) illustrates the steps whereby a Member Subscriber who is an Originating Lister can build a PDF Flyer which can be used by the Originating Lister and also shared with and re-branded by other Member Subscribers for marketing to their respective Prospects and Customers electronically as a link or an email attachment for viewing or downloading to a printer for a Custom Branded/Re-branded hard copy of the Property Listing's features.

150, 152, 154, 156, 158 indicate the necessary activities of completing the individually unique Branded Listing Profiles for each of the original Property Listings acquired by the hypothetical Agents “A” 150, “C” 154, “D” 156, and “E” 158 and are shown again by way of reference.

More specifically illustrated, from the “Add Listings Page” 434, clicking “Build PDF Flyer” 550 opens the “Add PDF Flyer Page” 552. Where more than one Flyer Template is available, a drop down menu is provided 554 to select the desired look for the Flyer. Dramatic HD still images can be loaded into the provided spaces 556 and 558. Descriptive language is auto-populated at 444 but can be manually over-ridden if necessary by clicking “Edit Text” 560.

Clicking “Preview” 562 opens the “Preview New PDF Flyer Page” 562 where the Flyer will appear as it will look when published. The previously entered “Title” 440, “Sub-title” 442, and Description 444 appear as auto-populated from previous entries. A shorter descriptor 566 may also auto-populate from earlier input from the “Add Listing” data entry.

Along with the Agent Profile Matrix 338 and Social Media Links 526, the PDF Flyer has a system-generated QR Code 568 which allows a reader to link to the online Virtual Tour for the Listing that also includes the Agent's Contact Info. Further editing is possible by clicking “Edit” (lower right) 570. Clicking “Back to Listing” 548 returns to the “Add/Edit Listing Page” 434 from either the Preview Page 564 or the Add Flyer Page 552.

FIG. 6c (“Step 5”, continued) illustrates the process of building an online Printable .pdf Postcard of a Property Listing where such Postcard can be shared with and re-branded by other Member Subscribers for marketing to their respective Prospects and Customers.

150, 152, 154, 156, 158 indicate the necessary activities of completing the individually unique Branded Listing Profiles for each of the original Property Listings acquired by the hypothetical Agents “A” 150, “C” 154, “D” 156, and “E” 158 and are shown again by way of reference.

More specifically illustrated, from the “Add Listings Page” 434, clicking “Build PDF Postcard” 572 opens the “Add PDF Postcard Page” 574.

The Postcard has two sides, “Front” 578 and “Back” 582. The Front is custom set up by the Member Subscriber, while the back is auto-populated from the Listing data base. A drop down menu is provided 576 to select the desired size for the Postcard. Another Drop Down Menu or other type of input field is provided for the Postcard's headline 589.

A title for the Postcard (usually different from the previous Title 440 used elsewhere) is entered in the space marked “Title” 584. A large HD still image (or montage) is selected for display in the provided image space 586 to be directly uploaded or selected from the Member Subscriber's custom online gallery (not shown). With printable “real estate” at a premium, a shorter description (than the previous 444 description verbiage) is entered in the designated space 588.

The Postcard's reverse side is auto-populated with the Agent's Profile Grid 338, and a system generated QR Code 568 is added which links directly to the branded Virtual Tour.

Clicking “Preview” opens “Preview PDF Postcard” 592, revealing the Postcard as it will look when published. Further editing is possible by clicking “Edit” (lower right) 594. Clicking “Back to Listing” 548 returns to the “Add/Edit Listing Page” 434 from either the Preview Page 592 or the Add PDF Postcard Page 574.

FIG. 6d (“Step 5”, continued) illustrates the process of building a Custom Branded Standalone Video Tour that can be used to market the Listing to the Originating Member Subscriber's prospective clients. As well, unique to the present invention, such Custom Branded Videos can be shared by the Originating Lister Member Subscriber with other Member Subscribers and Custom Re-branded by the System for downloading or viewing online for marketing to their respective Prospects and Customers.

150, 152, 154, 156, 158 indicate the necessary activities of completing the individually unique Branded Listing Profiles for each of the original Property Listings acquired by the hypothetical Agents “A” 150, “C” 154, “D” 156, and “E” 158 and are shown again by way of reference.

More specifically illustrated, from the “Add Listings Page” 434, clicking “Build Stand-alone Video” 596 opens the “Add Stand-alone Video Page” 598.

The previously added “Title” auto-populates in section 440 as does the “Sub-title” in section 442. A successful Stand-alone Video uses carefully selected multi-media to tell the sales story of the Property being presented while limiting the finished rendered video to between one and a half to two minutes. 600 draws attention to the types of material the system is designed to use in presenting a successful Tour, such as full 1080 HD still images, still panoramas, and video clips. Audio clips for background sound and narration can also be uploaded. Any visual element added represents a “Scene” 604. Additional Scenes can be made available beyond the scene spaces already provided by clicking 628, and scrolling between currently visible and previous or later scenes is accomplished by clicking 602 and 630 respectively.

The manner in which one Scene follows or flows into the next is referred to as a “Transition” which can be added concurrently with the addition of a Scene or at any other time after, including after all graphical elements are in place. Clicking 606 starts the “Add Transition” process by opening the “Add Scene Transition” page 608. 610 indicates the “Previous Scene” at the point of a Transition insertion and 616 indicates the Scene that follows. Scrolling between Scenes and Transitions is accomplished by clicking 612 for “Previous” and 618 for “Next”. 614 and 620 call attention to the types of Transitions that might be available or appropriate between Scenes, and 622 indicates a Viewer that allows the auditing of any particular Scene to Scene Transition. Clicking “Submit” 624 locks the Transition in place and sends the process back to the “Add Stand-alone Video Page” 598 unless the Transition is further edited then or at a later time. Unique to the present invention is the facilitation of branding Stand-alone Videos as part of the Marketing Materials where such branding is integral to the video and yet the videos can be shared with and Custom Re-branded by others with their own Custom Branded Intros and Endings affixed, independent of browsers, media players, or the reliance on metadata (as in U.S. Pat. No. 8,201,201 B2).

From the “Add Stand-alone Video Page” 598, clicking “Add Branded Intro” 614 opens the “Add Branded Video Intro” page 616. This page works exactly as the Stand-alone Video page, except that it is dedicated to creating a Custom Branded Stand-alone Video Introduction which the system of the present invention will merge with the finished Listing Video. Clicking “Render Video” (lower right) 636 will render the Custom Branded Video Intro independently of the Listing Video for multiple uses (as showing on the Agent Profile Page or including in emails) as well as making it available for merging when included with the Originally Branded Marketing Materials or for later removing/substituting if the Property Listing is selectively shared with other Member Subscribers.

Similarly, from the “Add Stand-alone Video Page” 598, clicking “Add Branded Ending” 638 opens the “Add Branded Video Ending” page 640. This page works exactly as the Stand-alone Video page and the Add Custom Intro Page, except that it is dedicated to creating a Custom Branded Stand-alone Video Intro which the system of the present invention will merge with the finished Listing Video. Clicking “Render Video” (lower right) 636 will render the custom video intro independently of the Listing Video for multiple uses as well as making it available for merging when included with the Originally Branded Marketing Materials or for later removing/substituting if the Property Listing is selectively shared with other Member Subscribers.

When the Stand-alone Video Scenes and Transitions are complete, clicking the “Render Video” button 636 from the “Add Stand-alone Video Page” 598 will send the video file to the online data processing center for rendering into a completed Custom Branded Stand-alone Video, complete with the Custom Branded Intro and Ending video clips which, as a merged single file, can be shared across platforms without the onus or potential threat of an executable file or the intervention of a specific browser or viewer or dependence upon metadata (as in U.S. Pat. No. 8,201,201 B2).

FIG. 7 (“Step 6”) illustrates a package of some of the Branded Marketing Materials that can be built online for marketing Property Listings directly to the public whether or not such Property Listings and their Marketing Materials are selectively shared with and re-branded by other Member Subscribers for marketing to their respective Prospects and Customers.

160, 162, 164, 166, 168 indicate that the previous activities of hypothetical Agents “A-E” (150, 152, 154, 156, 158) result in uniquely Branded Listings when published by the Original Listing Agents as represented by the hypothetical Agents “A” 160, “C” 164, “D” 166, and “E” 168. (Agent “B” with no original Listings has no Branded Products to show at this point 162.) The resulting Branded Products are more fully illustrated by a set of the Marketing Materials as they might appear for hypothetical Agent “A” as “Agent ‘A’ Branded Tour” 642, “Agent ‘A’ Branded Landing Page 644, “Agent ‘A’ Branded PDF Flyer” 646, “Agent ‘A’ Branded PDF Post Card” 648, and “Agent ‘A’ Branded Stand-Alone Video” 650.

FIG. 7a (“Step 6”, continued) illustrates the baseline and distinctively branded elements of a Custom Branded/Re-branded Virtual Tour of a Property Listing 642 as it might appear for marketing to a Member Subscriber's Prospects and Customers, in this case for the hypothetical Agent “A”, bearing these Custom Branding features: Custom Header/Banner/Logo 652, Agency Information 654, Custom Footer, Decorative Element, etc., 656, “Contact Agent” keyed to Agent “A” 658, “Download Video” with Custom Branded Intro and Ending 660, Personal Agent Photo 662, Agent Info 664, Direct View Agent Profile Link 666, and Custom Social Media Links 668.

FIG. 7b (“Step 6”, continued) illustrates the baseline and distinctively branded elements of a branded/re-branded Landing Page 644 of a Property Listing as it might appear for marketing to a Member Subscriber's Prospects and Customers, in this case for the hypothetical Agent “A”, bearing these Custom Branding features: Custom Header/Banner/Logo 652, Agency Information 654, Custom Footer, Decorative Element, etc., 656, “Download Video” with Custom Branded Intro and Ending 660, Personal Agent Photo 662, Agent Info 664, Direct View Agent Profile Link 666, Custom Social Media Links 668, Link to Agent “A” Custom Virtual Tour 670, Link to Print Custom PDF Flyer 672, and Custom Keyed Contact Message 674.

FIG. 7c (“Step 6”, continued) illustrates the baseline and distinctively branded elements of a branded/re-branded online Printable .pdf Flyer 646 of a Property Listing as it might appear for marketing to a Member Subscriber's Prospects and Customers, in this case for the hypothetical Agent “A”, bearing these Custom Branding features: Custom Header/Banner/Logo 652, Agency Information 654, Custom Footer, Decorative Element, etc., 656, Personal Agent Photo 662, Agent Info 664, Custom Social Media Links 668, and QR Code to Agent “A” Custom Virtual Tour 676.

FIG. 7d (“Step 6”, continued) illustrates the baseline and distinctively branded elements of a branded/re-branded online Printable .pdf Post Card 648 of a Property Listing as it might appear for marketing to a Member Subscriber's Prospects and Customers, in this case for the hypothetical Agent “A”, bearing these Custom Branding features: QR Code to Agent “A” Custom Virtual Tour 676 with Personal Agent Photo, Agent Contact Info, and Agency Info on reverse (not shown).

FIG. 7e (“Step 6”, continued) illustrates the baseline and distinctively branded elements of a Custom Branded/Re-branded Stand-alone Video Tour 650 of a Property Listing as it might appear for marketing to a Member Subscriber's Prospects and Customers, in this case for the hypothetical Agent “A”, bearing these Custom Branding features: Custom Header/Banner/Logo 652, Agency Information 654, Custom Footer, Decorative Element, etc., 656, Personal Agent Photo 662, Agent Contact Info 664, Direct View Agent Profile Link 666, and Custom Social Media Links 668, and QR Code to Agent “A” Custom Virtual Tour 676.

FIG. 8 (“Step 7”) illustrates the selective sharing preferences that Member Subscribers may choose for the visibility of their Property Listings to Prospects and Customers and for sharing with other Member Subscribers for re-branding of those Property Listings.

170, 172, 174, 176, 178 begin to illustrate what is so remarkably unique about the present invention. While the branding of marketing materials for property listings per se is not uncommon, the ability to selectively and purposely share those listings and materials with other professionals—where those listings and materials, especially in the form of Virtual Tours and Standalone Videos, can be custom RE-branded and made specific to a receiving professional—IS unique and is represented by the hypothetical Agents “A” 170, “C” 174, “D” 176, and “E” 178 choosing the preferences that will govern the sharing activities having to do with each of their originally Listed and Branded Property Listings. (Agent “B” with no original Listings has no activities germane to this function 172.)

The “Listing Sharing Preferences Page” 670 is used to establish the selective parameters surrounding the sharing of a particular Original Property Listing which is brought to the fore via the drop down menu 608.

First consideration (left column) is the “Public Display” 682 which offers options ranging from the extremes of totally keeping a listing private and unaccessible all the way to allowing completely unrestricted public search/access/viewing.

Second consideration has to do with “Private Re-branding/Labeling” 684 where options span from disabling the re-branding feature altogether all the way to allowing all Member Subscribers to Re-brand/Private Label an Original Listing.

Clicking the box 686 allows the automatic approval of Private Label Requests without any manual interaction. Preferences are recorded to the data base and made active by clicking “Approve” 688.

FIG. 9 (“Step 8”) illustrates the interaction between Agents “A”-“E” where Original Listings are being offered for sharing and Re-branding under Private Label —180a, 182a, 184a, 186a, 188a—and received by the Invitees —190a, 192a, 194a, 196a, 198a. It also depicts what an invitation form to share and re-brand a Property Listing might look like whether the initiating Member Subscriber chooses to handle the process manually 690 or automate the process within the system's Friends Network.

Clicking a box at 362 limits the invitation to the selected group—in this case, “Professional Members”. Among that group, a pull down menu accesses a specific subset of choices which can auto-populate or receive manual input (shown as “From 416”), E-mailing parameters are selected or typed in along with an appropriate greeting 626. E-mails are more likely to be read if accompanied by a catchy “Subject” which can be entered at 632.

440 and 442 supply previously entered data for “Title” and “Sub-title” respectively while the Property Listing's Address is also supplied 438.

To showcase the Property Listing to those to whom an invitation will be sent, the system auto-generates and posts an online Custom Branded Virtual Tour which auto-populates at 670 as does the unique Property Identifier 458. Although a new image can be substituted, the default image previously chosen shows up at 436. Description fills in from the data base at 444, leaving it up to the Inviting Member Subscriber to address any special Features/Instructions/Conditions or Other Info 694.

The type of invitation response sought may be set by the sender and selected from the drop down menu at 696 and 698. An active calendar 700 (or a place for the date) allows the recipient to date the acceptance of the Invitation when clicking on “Reply Here” 702. The “Re-brand Share Invite” is sent to the targeted recipient by clicking “Send Invite” 410.

FIG. 10 (“Step 9”) illustrates the interaction between Agents “A”-“E” where Original Listings have been offered for sharing and the invitations have been received and are in the process of being selectively accepted for sharing and Re-branding under Private Label by the Invitees —190b, 192b, 194b, 196b, 198b—and confirmed back to the Inviters—180b, 182b, 184b, 186b, 188b—and received. It further depicts what a Re-brand Acceptance and Re-brand Authorization for a Property Listing might look like whether the initiating Member Subscriber chooses to handle the process manually or to automate the process within the system's Friends Network.

A “Re-brand Share Acceptance” 704 contains the Invitee's Contact Information 706 (usually generated from the Original Lister's Friends Contacts Data Base), the Subject Line 632 (which directly references the specific Listing in question, the Listing's “Title” 440 and “Sub-title” 442, and the Property's Address 438. Specific Acceptance is made by way of 696 and 698, and any “Special Features/Instructions/Conditions are also addressed 694. The acceptance response is dated 700 and sent back by way of “Reply” 702.

Formal confirmation of the Acceptance may be sent back via “Re-brand Listing Authorization” 708. This would include the Invitee's Identifying Information 706, the Subject's Listing Title 440, and the Property Address 438. Any Special Conditions, etc., 694 would also be referenced. Authorization would include the secure share link 710 and the Authorization Date 712, and the form is sent back by return “Send” 714.

FIG. 11 (“Steps 10 & 11”) illustrates the interaction between Agents “A”-“E” where Original Listings may or may not have been offered to others for sharing and the steps that can be taken by a Member Subscriber (Agent “D” 206, 216) to secure authorization for sharing a Re-branded Property Listing (from Agent “E” 208, 218) where there has not been a specific or blanket invitation to do so from the Listing's initiating Member Subscriber. Agents “A”, “B”, and “C”—200, 202, 204, 210, 212, 214—are not party to this activity.

Pictured are two of many ways that hypothetical Agent “D” might have learned of desirable new Listings belonging to hypothetical Agent “E”, even though Agent “E” did not send out sharing Invites for them. Member Subscribers can access the “Agent's Listings Page” 716 of other Member Subscribers 718, 720. Agents are identified by their Agent Profile Matrix 338, and following each posted Listing is a “Request Share” link 722.

Similarly, there is a “New Listings Page” 724—available only to Member Subscribers who have signed in 720—that allows targeted searches by “Area”, “Type”, and “Price” (or other available filters) 726. Each posted Listing can be Share Requested 722, and the Original Lister has the discretion as to whether or not to share when requested.

FIG. 12 (“Step 12”) illustrates a potential package of Custom Branded Marketing Materials built by initiating Member Subscribers where the branding has been stripped off the Marketing Materials in the process of selectively sharing those materials with other Member Subscribers (hypothetical Agents “A”, “B”, “C”, “D”, and “E”—220, 222, 224, 226, 228) for purposes of their re-branding them for marketing to their own Prospects and Customers. Shown are from hypothetical Agent “A”: “Tour—Brand Neutral” 728, “Landing Page—Brand Neutral” 730, PDF Flyer 732, PDF Printable Post Card—Brand Neutral” 734, “Stand-Alone Video—Brand Neutral” 736. All items are complete except for the Original Custom Branding that has been removed by the System for sharing with other Member Subscribers.

FIG. 13 (“Step 13”) illustrates the System's treatment of Originally Branded Virtual Tours where the initial Member Subscriber's branding is stripped away in the process of selectively sharing the Property Listings with other Member Subscribers (hypothetical Agents “A”, “B”, “C”, “D”, and “E”—220, 222, 224, 226, 228), and the unique branding of the receiving Member Subscribers is electronically substituted, and/or merged, and/or overlaid by the System onto the shared Virtual Tour for the purpose of promoting the newly Re-branded and Shared Virtual Tour with the Prospects and Customers of the receiving Member Subscribers.

“Original Tour from Agent ‘D’ Stripped by System of Originator's Branding” 738 is transformed into “Tour Shared from Agent ‘D’ Rebranded within System for Agent ‘A’” 740. “Original Tour from Agent ‘A’ Stripped by System of Originator's Branding” 742 is transformed into “Tour Shared from Agent ‘A’ Re-branded within System for Agent ‘C’” 744. “Original Tour from Agent ‘D’ Stripped by System of Originator's Branding” 746 is transformed into “Tour Shared from Agent ‘D’ Re-branded within System for Agent ‘E’” 748.

FIG. 13a (“Step 13”, Continued) illustrates a Virtual Tour related to a Property Listing initiated by one Member Subscriber 750 who then selectively shares the Virtual Tour with three other Member Subscribers 762 where the System strips the Tour of its Original Branding and uniquely Re-brands the Tour for the receiving Member Subscribers.

Originating Lister (hypothetical Agent “A”) creates a Custom Branded Agent “A” Intro 752 and a Custom Branded Agent “A” Ending 760. The present invention's system automatically selects and merges 754 the Agent “A” Custom Branded Intro 752 to Agent “A's” Listing Video 756. The System then automatically selects and merges 758 the Agent “A” Custom Branded Ending 760 to the video so that the video is seen whenever and wherever viewed by Agent A's″ Prospects as Agent “A's” Custom Branded Stand-alone Video.

Agent “A” Shares the Agent “A” Original Listing Video with three other Member Subscriber Real Estate Professionals.

Upon accepting the shared Listing from Agent “A”, Agent “B” creates a Custom Branded Agent “B” Intro 764 and Ending 766. The present invention's system automatically selects and merges 754 the Agent “B” Custom Branded Intro 764 to Agent “A's” Listing Video 756. The System then automatically selects and merges 758 the Agent “B” Custom Branded Ending 766 to the video so that the video is seen whenever and wherever viewed by Agent “B's” Prospects as Agent “B's” Custom Branded Stand-alone Video.

Upon accepting the shared Listing from Agent “A”, Agent “C” creates a Custom Branded Agent “C” Intro 768 and Ending 770. The present invention's system automatically selects and merges 754 the Agent “C” Custom Branded Intro 768 to Agent “A's” Listing Video 756. The System then automatically selects and merges 758 the Agent “C” Custom Branded Ending 770 to the video so that the video is seen whenever and wherever viewed by Agent “C's” Prospects as Agent “C's” Custom Branded Stand-alone Video.

Upon accepting the shared Listing from Agent “A”, Agent “D” creates a Custom Branded Agent “D” Intro 772 and Ending 774. The present invention's system automatically selects and merges 754 the Agent “D” Custom Branded Intro 772 to Agent “A's” Listing Video 756. The System also automatically selects and merges 758 the Agent “D” Custom Branded Ending 774 to the video so that the video is seen whenever and wherever viewed by Agent “D's” Prospects as Agent “D's” Custom Branded Stand-alone Video. This re-branding functionality and full-screen presentation is consistent across all platforms and viewing devices.

FIG. 13b (“Step 13”, Continued) illustrates Stand-alone Videos related to Property Listings initiated by two Member Subscribers and selectively shared with each other and respectively re-branded for marketing to their own unique Prospects and Customers.

Originating Lister Agent “D” creates a Custom Branded Agent “D” Intro 776 and a Custom Branded Agent “D” Ending 784. The present invention's system automatically selects and merges 778 the Agent “D” Custom Branded Intro 776 to Agent “D's” Listing Video 780 and also automatically selects and merges 782 the Agent “D” Custom Branded Ending 784 to the video so that the video is seen whenever and wherever viewed by Agent D's″ Prospects as Agent “D's” Custom Branded Stand-alone Video.

Agent “D” Shares the Agent “D” Original Listing Video with another Member Subscriber Real Estate Professional, Agent “E”.

Upon accepting the shared Listing from Agent “D”, Agent “E” creates a Custom Branded Agent “E” Intro 786 and a Custom Branded Agent “E” Ending 788. The present invention's system automatically selects and merges 778 the Agent “E” Custom Branded Intro 786 to Agent “D's” Listing Video 780 and also automatically selects and merges 782 the Agent “E” Custom Branded Ending 788 to the video so that the video is seen whenever and wherever viewed by Agent “E's” Prospects as Agent “E's” Custom Branded Standalone Video.

Originating Lister Agent “E” creates a Custom Branded Agent “E” Intro 790 and a Custom Branded Agent “E” Ending 794. The present invention's system automatically selects and merges 778 the Agent “E” Custom Branded Intro 790 to Agent “E's” Listing Video 792. The System then automatically selects and merges 782 the Agent “E” Custom Branded Ending 794 to the video so that the video is seen whenever and wherever viewed by Agent E's″ Prospects as Agent “E's” Custom Branded Stand-alone Video.

Agent “E” Shares the Agent “E” Original Listing Video with another Member Subscriber Real Estate Professional, Agent “D”.

Upon accepting the shared Listing from Agent “E”, Agent “D” creates a Custom Branded Agent “D” Intro 796 and a Custom Branded Agent “D” Ending 798. The present invention's system automatically selects and merges 778 the Agent “D” Custom Branded Intro 796 to Agent “E's” Listing Video 792 and also automatically selects and merges 782 the Agent “D” Custom Branded Ending 798 to the video so that the video is seen whenever and wherever viewed by Agent “D's” Prospects as Agent “D's” Custom Branded Standalone Video.

FIG. 14 (“Step 14”) illustrates what might be the net increase in the number of Custom Branded/Re-branded Property Listings offered by each of five Member Subscribers as a result of selective sharing of Property Listings among them as well as the resulting increase in the exposure that their Original Listings receive being shared among other Member Subscribers.

Having received the Selectively Shared Listings of “C1, C2, C4, & C6”, and “D1-D3”, hypothetical Agent “A” 240 grows the number of branded Listings from her original four (4) to a total of eleven (11), an increase of 275% with an additional 250% increase in exposure for Agent “A's” Original Listings 800. Agent “B” 242, who started with zero (0) Original Listings, now shows thirteen (13), a 1300% increase 802. The Agent “C” team 244 grows from six (6) Original Listings to eleven (11), almost doubling (183.33%) their ability to market properties to their Prospects while increasing the exposure of their Original Listings by 267% 804. Agent “D” 246 with three (3) Original Listings now boasts 10 total Branded/Re-branded Listings, a 333% increase in available Branded Inventory and a boost of 500% for Agent “D's Original Listings Exposure 806. And even Agent “E” 248, who started with two (2) Original Listings, now offers five (5), a 250% boost in available Listings and has doubled the exposure of one of his Listings, a 50% overall exposure increase 808.

FIG. 15 (“Step 15”) illustrates the scope and flexibility of the Marketing Materials that can be generated by the System for selective sharing among Member Subscribers. All Marketing Materials—Virtual Tours 728, Landing Pages 730, PDF Flyers 732, PDF Post Cards 736, and Standalone Videos 734—are automatically responsive, fitting their displays to the highest optimal resolution and load speed across all platforms and media, whether PC 810, Tablet 812, or Smartphone 814, giving a consistent look, feel, and customer experience—currently unique for any virtual tour site.

FIG. 15a (“Step 15”, Continued) illustrates the range of internal BackOffice online tools for use by Member Subscribers in managing and promoting their Original and Re-branded Property Listings: “My Network Page”—360, from which Friends and Contacts are tracked and managed; “Invite Contacts Page”—404, for gaining exposure to Member content; “Add Client Contact”—816, for building Contact Data Base; Edit/Manage Client Contact” 818, for better cataloging and accessing contact assets; “Edit/Manage Groups”—412, essential for regulating the flow of information and sharing for maximum marketing potential; “Private Messages Page” 820, for keeping in communication with Professionals and Prospects; “View Messages Page”—822, for staying current with correspondence; “My Leads Page”—824 for keeping up with customer interest and demand; and “Analytics Page”—826, for following the marketing efforts among the share groups for more efficient time and asset management.

FIG. 15b (“Step 15”, Continued) illustrates potential online pages visibly accessible by the public in the promotion of a Member Subscriber's Initial and Shared/Re-branded Property Listings: “Search Properties”—828, for easy public access to searchable available inventory; “Agent's Listings Page”—716, for Agent specific (Branded and Re-branded) inventory; “New Listings Page”—724, for charting the latest new Listings to come available; “View Agent's Profile”—830, for building Agent Branding; “Add/Edit Testimonial Page”—832—and “My Testimonials Page”—834, both for building Prospect familiarity, trust, and loyalty.

FIG. 16 (“Step 16”) illustrates the role the present invention's Optional Lead Protection System plays in helping Member Subscribers track and hold onto Leads from contacts they have made in promoting branded/re-branded Property Listings where the same Prospect has received multiple contacts from multiple Member Subscribers regarding the same Property Listing.

Illustrates (self-explanatory Sub-steps 1-6) scenario where Prospect 836 receives duplicate advertisements for the same Listings from multiple Member Subscribers 836, 840, 842, 844, and 846, responding to one of them 848, and charts the steps through the process whereby the System (with certain limitations) works to try to track the first contact response and attempts to preserve that first contact as the exclusive lead for the Property Listing, whether Originally Branded or Shared and Re-branded, of the Agent to whom the Prospect responded. The System is designed to encourage the Prospect to create a two-way link to that Agent of first contact 850. The System is also designed (if the Member Subscriber so authorizes) to communicate with that Agent (email, text message, or both) when the Prospect does leave contact information 852. Thereafter, within the limitations of the System and the Prospect's use, the System will redirect all queries for the Property in question originating from the same email or search device to the Agent of first contact 854.

FIG. 16a (“Step 16”, Continued) illustrates the role the present invention's Optional Lead Protection System plays in helping Member Subscribers track and hold onto Leads from contacts they have made in promoting Originally Custom Branded or Shared and Custom Re-branded Property Listings where the same Prospect has received multiple contacts from multiple Member Subscribers regarding multiple similar Property Listings.

Illustrates (self-explanatory Sub-steps 1-8) scenario where Prospect 836 receives advertisements for Listings from multiple Member Subscribers—836, 840, 842, 844, and 846, where same Members also represent duplicate Properties and Prospect responds to three of them 856, 858, and 860. The illustration also charts the steps (self-explanatory Sub-steps 1-8) through the process whereby the System (with certain limitations) works to try to track the first contact response in each instance and attempts to preserve that first contact as the exclusive lead for the Property Listing, whether Originally Custom Branded or Shared and Custom Re-branded, of the Agent to whom the Prospect first responded. The System is designed to encourage the Prospect to create a two-way link to each Agent of first contact 850 and communicate with each such Agent when the Prospect does so 852. Thereafter, within the limitations of the System and the Prospect's use, the System will redirect all queries for the Property in question originating from the same email or search device to the Agent of first contact 854. Illustrates “Agent's Listings Page” 862 where Prospect may be exposed to duplicate postings of a property already seen.

FIG. 16b (“Step 16”, Continued) illustrates the role the present invention's Optional Lead Protection System plays in controlling the visibility and redirection of links to Property Listings where a Prospect may have seen and responded to more than one invite from more than one Member Subscriber where the responses might otherwise conflict with previous contacts with other Member Subscribers over the same Property Listings.

Illustrates (self-explanatory Sub-steps 1-5) scenario where Prospect 836 receives duplicate advertisements for the same Listings from multiple Member Subscribers 836, 840, 842, 844, and 846, responding to four of them: 856—response to Agent “B”'s Custom Re-brand of Agent “C's” Original C1 Listing; 848—response to Agent “C” as a Custom Re-brand of Agent “A's” Original A1 Listing; 858—response to Agent “D” as an Original Brand of Agent “D's” D1 Listing, and 860—response to Agent “E” as an Original Brand of Agent “D's” E2 Listing. FIG. 16b charts the steps through the process whereby the System (with certain limitations) works to try to track the first contact response in each instance and attempts to preserve that first contact as the exclusive lead for the Property Listing, whether the Original Custom Branded or Shared and Custom Re-branded, of the Agent to whom the Prospect responded. Once contact is established regarding a particular Property Listing, within the limitations of the System and the Prospect's use, the System attempts to redirect all queries for the Property in question originating from the same email or search device to the Agent of first contact.

Hence, Prospect's later inquiry regarding A1 848 on Agent “A's” site 862 (black icon 876), though Original with Agent “A” (or Custom Re-branded on Agent “B's” site 864 (black icon 876) will forward to 848 on Agent “C's” site 866 as first contact (indicated by white icon 872). Future clicks on D-1 on any site other than “D's” 858 will go to Agent “D's” site 868 (white icon 872) rather than to Agent “A” 862, Agent “B” 864, Agent “C” 866, or Agent “E” 870 (all black icons 876). C-1 856 prioritizes to Agent “B” as first contact (white icon 872). And Agent “E” 870 is given precedent as first contact for E-2 860 (white icon 872).

Remaining un-contacted shared Property Listings (grey icons 874) are available for viewing, wherever displayed and discovered, on a first-come, first-served priority basis.

While the present invention has been related in terms of the foregoing embodiments, those skilled in the art will recognize that the invention is not limited to the embodiments depicted. The present invention can be practiced with modification and alteration within the spirit and scope of the amended claims. Thus, the description is to be regarded as illustrative instead of restrictive on the present invention.

What is claimed is:

1. A server driven subscription system, whether or not for fee, for marketing custom branded inventory via single and/or multiple mono and/or mixed media, which inventory and media can also be custom re-branded within and by said system, such system comprising—at least one server/system;
at least one database section;
at least one user accessible interface to function as back end subscriber-accessed dashboard/back office;
at least one publicly accessible front end interface, typically including a system-assigned subscriber area for the presentation of subscriber's materials and/or media;
optionally, at least one selectively accessible front end interface;
at least one internet access device, such as, but not limited to
a computer and/or computer network, and/or
a smartphone, and/or
a mobile accessing device of virtually any sort,
whereby at least one authorized subscriber is able to populate an electronic inventory list—otherwise known as (a) “listing(s)”—
comprising at least one item of lawful goods and/or services and/or collections of same, whether such item/s and/or collection/s be original with the subscriber or shared from or authorized by others,
regardless of type, form, and/or format of said inventory data,
howsoever such data/listing(s) be entered/sourced/made available/compiled/edited, including, but not necessarily limited to, where such data/listing(s) may be supplied from data from an outsourced data base such as, but not limited to, a Multiple Listing Service/IDX database,
from wheresoever such data/listings/related materials be stored/retrieved,
whether such inventory is actual or virtual,
where such inventory item(s)/lists(s) may at any time be selectively added to/edited/reordered/removed,
where such inventory may be continually updated relative to the status/availability of any listing offered or advertised by any registered subscriber on same's subscription site;
where such inventory item(s)/lists(s) may at any time receive originating subscriber's input resulting in system-generated/created additional marketing materials, where such marketing material(s), howsoever comprised,
are not limited by type, extension, file size, content, use, accessibility, form, or format(s), howsoever published/publishable/viewed/viewable/printed/printable/downloaded/downloadable/shared/shareable,
may include, but not be limited to, any one or more of any of
still photographs,
motion photographs,
pictures,
drawings,
renderings,
animations,
illustrations,
maps,
charts,
3-D representations in any form or format,
CGI (“Computer Generated Images”),
audio—in any form, whether singly or in multiple/s, howsoever and wheresoever played or made available,
video—in any form, whether singly or in multiple/s, howsoever and wheresoever displayed or made available,
panoramas,
180 representations,
360 representations,
global representations,
slide show presentations,
“virtual tours”,
flyers,
post cards,
brochures,
leaflets,
documents,
manuals,
booklets,
books,
posters,
informational pages,
emails,
landing pages,
capture pages,
blogs,
blog articles,
where any and all original inventory items—a/k/a “listing(s)”—and related marketing materials—a/k/a “media kit(s)”—receive the custom branding of the online subscription-based presence/persona of said originating subscriber,
where such system-published and/or hosted listing(s)/marketing materials/media is/are in any way marketed to/held out to/viewable by/offered to any segment of the consuming population,
via means provided within the system, and/or
using the internal communications tools within the system, and/or
utilizing the customizable web pages within the system, and/or
utilizing the contact management features of the system,
where such marketing of inventory may be conducted solely by said at least one originating authorized subscriber, and/or
where said at least one originating subscriber may wish to selectively solicit help in marketing said inventory,
whereby said at least one originating subscriber with a listing may wish to selectively communicate with at least one qualified subscriber or a network of same either externally or via means built within the functionality of the system, and
whereby said communication(s) may include, perhaps among others, at least one of
direct messaging,
email,
SMS,
facsimile,
whereby said at least one originating subscriber—a/k/a “inviting subscriber”—may wish to selectively invite from said network or elsewhere at least one other qualified subscriber
a/k/a “invited subscriber”—to share one or more of—
at least one of said inviting subscriber's original listings—a/k/a “shared listing”—for purposes of the expedited marketing of said inventory, and/or
at least one item of said shared listing's media kit,
whereby the at least one invited subscriber has the opportunity of accepting or rejecting the offer of such shared listing and/or media, and
whereby the at least one invited subscriber can communicate back to the inviting subscriber—via the system or otherwise—the choice to accept or reject the offer of such shared listing and media, and
whereby, upon confirmation of the acceptance by the at least one invited subscriber, the system allocates a duplicate of the content of said shared listing and/or any shared media to the at least one invited consenting receiving subscriber, and
whereby, upon receipt of the duplicated content by the at least one invited consenting receiving subscriber, any and all custom branding of the at least one inviting subscriber is removed by the system from such duplicate of the said shared at least one listing and/or any shared media, and
whereby the system replaces the removed original branding of the duplicated at least one inviting/sharing subscriber with the custom re-branding of the at least one online subscription-based presence/persona of said at least one invited/consenting/receiving subscriber,
whereby the at least one originating sharing subscriber at all times retains control of the content of the said at least one duplicated and shared listing and/or shared media, and
whereby changes made to the content by the originating sharing subscriber may be reflected in the duplicated content of the invited/receiving subscriber upon system retrieval;
whereby inventory and/or media showing up on at least one originating subscriber's publicly accessible system presence, may also show up as custom branded inventory and/or media on said at least one additional receiving subscriber's publicly accessible system presence;
whereby, listings and/or marketing media/materials published on a subscriber's publicly accessible system presence, whether such listings and/or marketing materials/media be original, shared, and/or supplied via another source, may be tracked by the system to help follow the online marketing efforts of same said at least one subscriber on behalf of all such listings and/or marketing media items;
whereby, when contact is made by an initiating subscriber with any at least one prospect via any of the system's functions/functionalities related to any of the listings and/or marketing media/materials within said initiating subscriber's control, should the contacted prospect respond back via any of the system's functions/functionalities, the system may work to preserve the unique prospect/client identity/relationship on behalf of the initiating subscriber,
and, additionally, whereby at least one subscriber may, optionally, establish and maintain chronological information as related to any type of event or events that relate to any of the listings, materials, and/or purposes of such subscriber or group of subscribers.

2. The method of claim 1 whereby the system is able to directly accomplish its purposes discretely and internally without the use of and independent from meta data or specialty viewers or other such intervening devices.

3. The method of claim 1 whereby any at least one authorized subscriber is able to selectively enter/upload/transfer/exchange/compile/edit/manipulate/store data, of any and all types, from one or multiple sources, whether simultaneously or otherwise, via any means, where such data includes, but is not limited to, any and all digital/alphanumeric/graphical/multimedia data/files—irrespective of file size(s), content, use, accessibility, form, format(s), extension(s), etc.

4. The method of claim 1 whereby any at least one authorized inventory-originating subscriber is able to input/upload digital data and representations of items of subscriber-originated inventory—a/k/a “original inventory” or “original listings”.

5. The method of claim 1 whereby any at least one authorized subscriber may selectively build/rearrange/edit viewable digital pages/products
via addable/removable content blocks of varying types,
each content block having editing capabilities within itself,
which content blocks can be dragged and dropped at will by said at least one subscriber to sort block order, and
which content blocks are automatically saved in position and locked into place upon being dragged and dropped, and
which content management functionality is uniform across all editable pages.

6. The method of claim 1 whereby at least one originating subscriber can, via said system, custom brand said original listing(s) to themselves and/or their business persona(s).

7. The method of claim 1 whereby said at least one authorized subscriber can, via said system, custom create/generate at least one item of or collection(s) of advertising/marketing materials of multiple types and media—collectively, “media kit(s)”—for said at least one original listing.

8. The method of claim 1 whereby said at least one authorized subscriber can, via said system, custom brand each item within said at least one media kit to themselves and/or their business persona(s).

9. The method of claim 1 whereby said at least one authorized subscriber can use the system to market same's own inventory of original listings to their selected audience(s) without any interaction with any other subscriber(s).

10. The method of claim 1 whereby said authorized subscribers can choose to selectively invite at least one other qualified invited subscriber to aid in the marketing of said at least one authorized inviting subscriber's at least one original listing.

11. The method of claim 1 whereby said at least one inviting subscriber, upon acceptance of at least one invited qualified subscriber, can share with such invited accepting subscriber the duplicated content of said authorized inviting subscriber's original at least one listing and/or at least one item from the at least one of the original related media kit materials—collectively, the at least one “accepted listing”.

12. The method of claim 1 whereby the system facilitates the removal of the original custom branding from an inviting subscriber's at least one shared listing and/or any of the at least one shared item of media material.

13. The method of claim 1 whereby the system facilitates the custom re-branding of the accepting subscriber(s) and/or same's business persona on any of at least one accepted shared listing and/or any at least one item of previously custom branded media material.

14. The method of claim 1 whereby the system allows selective online publication of any registered subscriber's custom branded and/or custom re-branded listings and marketing media—regardless of type or purpose—to appear singly or in part on at least one separate page—a/k/a “landing page”, “capture page”, video viewing page, e-flyer, e-card, social post, email, tour, and any and all such like—of the registered subscriber's publicly accessible subscription presence.

15. The method of claim 1 whereby the system allows the automatic generation of a live link featured on any directly or indirectly forwarded or socially shared “landing page”, “capture page”, posting, email, tour, flyer, e-card, etc., that connects an end user/viewer/reader back to the system's site of origin from which the sending subscriber initiated the communication, whether the communication was regarding an originally custom branded or shared rebranded listing or marketing item.

16. The method of claim 1 whereby the system allows sending data to IDX/MLS (Multiple Listing Service) or other data bank(s) on demand and presenting such data stripped of custom branding as required by the protocol of any such receiving data bank where “vanilla” (unbranded) data (as in the case of “unbranded tours”) is the mandated norm.

17. The method of claim 1 whereby the system allows exchanging data on demand—through a protocol known to the art as “syndication”—with other online databases related to websites and/or mobile apps and other such like that advertise/market similar products/services, where such databases welcome external data input/output—so that both branded and unbranded data can selectively flow from a registered subscriber to such external database as the data exchange requires or allows.

18. The method of claim 1 related to custom re-branded inventory items/listings and associated site-generated advertising/marketing materials—whereby the at least one listing and all item-related content—outside of the custom re-branding elements—
a. remain at all times under the control of the originating inviting and generating subscriber;
b. are subsequently changed in the data being accessed by any and all sharing invitee subscribers if materially changed by the originating inviting subscriber;
c. carry a statement on all custom re-branded listings and materials—whenever appropriate or required—regarding the identity of the originating subscriber source for the listing, (or, in the alternative, a statement that the originating subscriber IS the originating source for the listing);
d. may have its invitation to share selectively cancelled at any time at the sole discretion of the original sharing subscriber;
e. may have active access to its shared content selectively cancelled at any time (for cause) at the sole discretion of the original sharing subscriber.

19. The method of claim 1 whereby, when contact is made by an initiating subscriber with any at least one prospect via any of the system's functions/functionalities related to any of the listings and/or marketing media/materials within said initiating subscriber's control, should the contacted prospect respond back via any of the system's functions/functionalities, the system works to preserve the unique prospect/client identity/relationship on behalf of the initiating subscriber.

20. The method of claim 1 related to interfacing with random or directed visitors to the main publicly accessible subscriber's presence and/or specific subscriber content, whereby information is captured/stored related to the identity of the specific visitor and the identification of specific needs/interests of any such visitor as such needs/interests relate in any way to any available inventory stored within the system.

21. The method of claim 1 related to identifying, tagging, and preserving (where possible) the commission status claim of any active marketing subscriber upon the at least one unique visit of any visitor to a subscriber's publicly accessible presence, whereby—
a. upon an initial query/search from an anonymous/untagged/unregistered visitor to the invention's publicly accessible presence, any inventory item germane to said search/query can be located and the said visitor's query is, by default, her subscribers;
b. a unique visit to at least one subscriber's branded publicly accessible presence for any particular listing is identified and tagged so that future visits by the same tagged/identified/registered visitor looking for the same listing are defaulted back to the same first visited subscriber's publicly accessible presence for said same listing, whether or not said listing is originally custom branded or shared and re-branded to such subscriber of first visit;
c. a unique visit to at least one subscriber's branded publicly accessible presence for any particular listing is identified and tagged so that future queries by same visitor from said subscriber's publicly accessible presence default to said subscriber's publicly accessible presence for any returned searches for inventory showing up as inventory, original or shared, for said subscriber;
d. a unique visit to at least one subscriber's branded publicly accessible presence for any particular listing is identified and tagged so that future queries by same visitor from said subscriber's publicly accessible presence default to said subscriber's publicly accessible presence for any returned searches for inventory showing up as inventory populated by system access to outside data sources (such as Multiple Listing Service/IDX data) is credited and custom branded to the same said subscriber from whose publicly accessible presence said query/queries may have originated.

22. The method of claim 1 related to—
a. sending custom subscription-site-generated emails to single or multiple recipients, where the data being posted on site-originated emails, SMS messages, social media posts, blogs, and such like bears the branding/re-branding, and/or contact information, and/or URL link(s), and/or call(s) to action of the subscriber(s) who generated and sent said emails, SMS/text messages, social media posts, blogs, and such like;
b. retaining on any forwarded custom subscription-site-generated email, SMS/text messages, social media posts, blogs, and such like the branding/re-branding, and/or contact information, and/or URL link(s) of the subscriber(s), and/or call(s) to action of the subscriber(s) who first generated and sent said original emails, SMS messages, social media posts, blogs, and such like through succeeding generations of forwarding/reposting, etc.

23. The method of claim 1 whereby, for purposes of affiliate marketing, permission can be granted by at least one originating subscriber to at least one invitee/receiving subscriber to selectively pass along custom-branded/rebranded listings/marketing media to multiple tiers of invitee/receiver subscribers for further custom rebranding and republication whereby succeeding generations of receiving/resending subscribers can selectively utilize the functionalities described in claim 1.
